(19) United States
(12) Patent Application Publication
(10) Pub. No.: US 2026/0259633 A1
(43) Pub. Date: Sep. 3, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventors: Seikou ABE, Osaka (JP); Minami NAKA, Osaka (JP)

(73) Assignee: PANASONIC INTELLECTUAL PROPERTY MANAGEMENT CO., LTD., Osaka (JP)

(21) Appl. No.: 19/655,341

(22) Filed: Apr. 22, 2026

Related U.S. Application Data
(63) Continuation of application No. PCT/JP2024/038887, filed on Oct. 31, 2024.
(60) Provisional application No. 63/546,993, filed on Nov. 2, 2023.

(30) Foreign Application Priority Data
Jun. 3, 2024 (JP) 2024-090277

(51) Int. Cl. G06F 3/04815; G06F 3/04817; G06T 11/60; G10L 15/26

(52) U.S. Cl. CPC G06F 3/04815; G06F 3/04817; G06T 11/60; G10L 15/26

(57) ABSTRACT

An information processing method includes: displaying a bird’s-eye view on a display of an information terminal; displaying, in the bird’s-eye view, a plurality of first icons respectively indicating a plurality of photographing spots in connection with photographing times; acquiring content information having been recorded; and displaying, in the bird’s-eye view, information showing association of the content information with a first icon having a photographing time that is closer to a recording time for the content information among the first icons.

### FIELD OF INVENTION

The present disclosure relates to a technology of displaying an image.

### BACKGROUND ART

For instance, Patent Literature 1 discloses a technology of; causing a mobile terminal to incorporate photographing identification information including a photographing position, a photographing direction, and time information in combination into a photograph image of a worksite having been photographed, and to send the photograph image incorporating the photographing identification information to a server; and causing the server to generate an icon from which the photographing direction and the photographing position are recognizable and store the generated icon, and to further display all icons generated in this manner in a map or a digital aerial photograph image of a region concerning the photographing position.

Unfortunately, the conventional technology described above merely displays, at a position in a map corresponding to a photographing spot, an icon indicating an image captured by the mobile terminal, and fails to display, in the map, an icon indicating content information being different from the captured image and having been additionally recorded. The conventional technology therefore needs further improvement. Besides, for access to the content information, the number of processing steps by a computer may increase, and hence, a burden on the computer may increase.

Patent Literature 1: Japanese Unexamined Patent Publication No. 2006-331260

### SUMMARY OF THE INVENTION

This disclosure has been accomplished to overcome the disadvantages described above, and has an object of providing a technology to: allow a user to be notified of presence of content information having being recorded, in addition to an image captured at a photographing spot; achieve a reduction in the number of processing steps for access to the content information; and achieve a reduction in the number of processing steps required by a computer for access to the content information, and hence achieve a reduction in the burden on the computer.

An information processing method according to an aspect of the present disclosure is an information processing method to be executed by a computer, and includes: displaying a bird’s-eye view on a display of an information terminal; displaying, in the bird’s-eye view, a plurality of first icons respectively indicating a plurality of photographing spots in connection with photographing times; acquiring content information having been recorded; and displaying, in the bird’s-eye view, information showing association of the content information with a first icon having a photographing time that is closer to a recording time for the content information among the first icons.

This disclosure allows a user to be notified of presence of content information having been recorded, in addition to an image captured at a photographing spot, and achieves a reduction in the number of processing steps for access to the content information. The disclosure further achieves a reduction in the number of processing steps required by a computer for access to the content information, and hence achieves a reduction in the burden on the computer.

### BRIEF DESCRIPTION OF THE DRAWINGS

FIG. 1 is a diagram showing an overall configuration of an information processing system in a first embodiment.

FIG. 2 is a first flowchart showing an example of a process by a second information terminal in the first embodiment.

FIG. 3 is a second flowchart showing an example of the process by the second information terminal in the first embodiment.

FIG. 4 illustrates an example display screen image to be displayed on the second information terminal when a second image is captured.

FIG. 5 is a first flowchart showing an example of a process by a server in the first embodiment.

FIG. 6 is a second flowchart showing an example of the process by the server in the first embodiment.

FIG. 7 illustrates an example design drawing screen image displayed on a first information terminal in the first embodiment.

FIG. 8 is diagram showing an overall configuration of an information processing system in a second embodiment.

FIG. 9 is a first flowchart showing an example of a process by a second information terminal in the second embodiment.

FIG. 10 is a second flowchart showing an example of the process by the second information terminal in the second embodiment.

FIG. 11 illustrates an example display screen image to be displayed on the second information terminal when sound recording is started in the second embodiment.

FIG. 12 illustrates an example display screen image to be displayed on the second information terminal when the sound recording is finished in the second embodiment.

FIG. 13 is a first flowchart showing an example of a process by a server in the second embodiment.

FIG. 14 is a second flowchart showing an example of the process by the server in the second embodiment.

FIG. 15 illustrates an example design drawing screen image displayed on a first information terminal in the second embodiment.

FIG. 16 is diagram showing an overall configuration of an information processing system in a third embodiment.

FIG. 17 is a first flowchart showing an example of a process by a second information terminal in the third embodiment.

FIG. 18 is a second flowchart showing an example of the process by the second information terminal in the third embodiment.

FIG. 19 is a first flowchart showing an example of a process by a server in the third embodiment.

FIG. 20 is a second flowchart showing an example of the process by the server in the third embodiment.

FIG. 21 is diagram showing an overall configuration of an information processing system in a fourth embodiment.

FIG. 22 is a first flowchart showing an example of a process by a second information terminal in the fourth embodiment.

FIG. 23 is a second flowchart showing an example of the process by the second information terminal in the fourth embodiment.

FIG. 24 is a first flowchart showing an example of a process by a server in the fourth embodiment.

FIG. 25 is a second flowchart showing an example of the process by the server in the fourth embodiment.

FIG. 26 illustrates an example design drawing screen image displayed on a first information terminal in the fourth embodiment.

FIG. 27 is a first flowchart showing an example of a process by a server in a fifth embodiment.

FIG. 28 is a second flowchart showing an example of the process by the server in the fifth embodiment.

FIG. 29 illustrates an example design drawing screen image displayed on a first information terminal in the fifth embodiment.

### DETAILED DESCRIPTION

Knowledge forming the basis of the present disclosure

A user interface has been developed to display, in a two-dimensional design drawing for a worksite or other site, a plurality of photographing spot icons respectively indicating photographing spots where the worksite is actually photographed, and to display an image captured at a certain photographing spot indicated by corresponding one photographing spot icon in response to selection of the one photographing spot icon. This configuration allows a manager of the worksite to grasp a situation of the worksite without visiting the worksite.

On the worksite, a first photographing device may photograph the worksite, and a second photographing device different from the first photographing device may photograph a part of the worksite in some cases. In such a case, a first image captured by the first photographing device and a second image captured by the second photographing device are separately managed. This may result in increasing the number of processing steps for access to the second image by a user in the user interface.

The technology of Patent Literature 1 merely displays, at a position in a map corresponding to a photographing spot, an icon indicating an image captured by a mobile terminal, and fails to display, in the map, an icon indicating content information being different from the captured image and having been additionally recorded.

The technology thus fails to notify the user of the presence of content information having been recorded, in addition to an image captured at a photographing spot, and has difficulty in reducing the number of processing steps for access to the content information. Besides, for access to the content information, the number of processing steps by a computer may increase, and hence, a burden on the computer may increase.

The following technologies will be disclosed to overcome the disadvantages.

(1) An information processing method according to an aspect of the disclosure is an information processing method to be executed by a computer, and includes: displaying a bird’s-eye view on a display of an information terminal; displaying, in the bird’s-eye view, a plurality of first icons respectively indicating a plurality of photographing spots in connection with photographing times; acquiring content information having been recorded; and displaying, in the bird’s-eye view, information showing association of the content information with a first icon having a photographing time that is closer to a recording time for the content information among the first icons.

This configuration includes displaying, in the bird’s-eye view, a plurality of first icons respectively indicating a plurality of photographing spots in connection with photographing times, and displaying, in the bird’s-eye view, information showing association of content information with a first icon having a photographing time that is closer to a recording time for the content information among the first icons.

The configuration therefore allows a user to be notified of presence of the content information having been recorded, in addition to an image captured at a photographing spot, and achieves a reduction in the number of processing steps for access to the content information. The configuration that allows the user to be notified of the presence of the content information having been recorded, in addition to the image captured at the photographing spot, further achieves a reduction in the number of processing steps required by a computer for access to the content information, and hence achieves a reduction in the burden on the computer.

(2) In the information processing method according to (1) above, the information may constitute a second icon different from the first icons.

This configuration allows the user to be notified of the presence of the content information having been recorded, in addition to the image captured at the photographing spot, owing to the second icon.

(3) In the information processing method according to (1) above, the information may constitute the first icon to be displayed differently from another first icon.

This configuration allows the user to be notified of the presence of the content information having been recorded, in addition to the image captured at the photographing spot, owing to the first icon to be displayed differently from another first icon.

(4) In the information processing method according to any one of (1) to (3), the first icons may be respectively associated with a plurality of first images captured by a first photographing device at the photographing spots, and the content information may include a second image captured by a second photographing device during capturing of the first images by the first photographing device.

This configuration includes acquiring a second image captured by the second photographing device during capturing of the first images by the first photographing device, and displaying, in the bird’s-eye view, information showing association of the second image with a first icon having a photographing time that is closer to a recording time for the second image among the first icons. The configuration thus allows the user to be notified of the presence of the second image captured near a photographing spot for a certain first image.

(5) In the information processing method according to any one of (1) to (3) above, the first icons may be respectively associated with a plurality of images captured by a photographing device at the photographing spots, and the content information may include sound information recorded by a sound recording device during capturing of the images by the photographing device.

This configuration includes acquiring sound information recorded by the sound recording device during capturing of the images by the photographing device, and displaying, in the bird’s-eye view, information showing association of the sound information with a first icon having a photographing time that is closer to a recording time for the sound information among the first icons. The configuration thus allows the user to be notified of the presence of the sound information recorded near a photographing spot for a certain image.

(6) In the information processing method according to any one of (1) to (3) above, the first icons may be respectively associated with a plurality of images captured by a photographing device at the photographing spots, and the content information may include text information input through an input device during capturing of the images by the photographing device.

This configuration includes acquiring text information input through the input device during capturing of the images by the photographing device, and displaying, in the bird’s-eye view, information showing association of the text information with a first icon having a photographing time that is closer to a recording time for the text information among the first icons. The configuration thus allows the user to be notified of the presence of the text information having been recorded near a photographing spot for a certain image.

(7) In the information processing method according to any one of (1) to (3) above, the first icons may be respectively associated with a plurality of images captured by a photographing device at the photographing spots, and the content information may include text information converted from sound information recorded by a sound recording device during capturing of the images by the photographing device.

This configuration includes acquiring text information converted from sound information recorded by the sound recording device during capturing of the images by the photographing device, and displaying, in the bird’s-eye view, information showing association of the text information with a first icon having a photographing time that is closer to a recording time for the text information among the first icons. The configuration thus allows the user to be notified of the presence of the text information having been recorded near a photographing spot for a certain image.

(8) In the information processing method in (2) above, the displaying of the information may include associating the second icon and the first icon with each other by an outline defining a predetermined shape.

This configuration includes associating the second icon and the first icon with each other by an outline defining a predetermined shape, and hence allows the user to easily recognize which specific first icon is associated with content information.

(9) In the information processing method according to (8) above, each of the first icons may be associated with a photographing direction in which a photographing device has captured an image at each of the photographing spots, and a certain point on a boundary of the first icon may be specified by the photographing direction associated with the first icon, and may be connected to the outline.

This configuration allows the user to know a photographing direction in which the photographing device has captured an image owing to a connection between the boundary of the first icon and the outline.

(10) In the information processing method in (2) above, the displaying of the information may include displaying the second icon at such a position as to avoid overlapping a character or a shape in the bird’s-eye view.

This configuration includes displaying the second icon at such a position as to avoid overlapping a character or a shape in the bird’s-eye view, and thus achieves improvement in visibility of the bird’s-eye view and the second icon.

(11) In the information processing method in (10) above, the bird’s-eye view may include a design drawing for a building, and the displaying of the information may include displaying the second icon in a blank inside the building shown in the design drawing, in a blank outside the building shown in the design drawing, or in an area except for a region including the first icons in the design drawing.

This configuration includes displaying the second icon in a blank inside the building shown in the design drawing, in a blank outside the building shown in the design drawing, or in an area except for a region including the first icons in the design drawing, and thus achieves improvement in visibility of the design drawing and the second icon.

(12) The information processing method according to (5) above may further include: determining whether the sound information includes utterances of a plurality of persons; and converting the sound information into text information. The displaying of the information may include further displaying the text information available to identify each of the persons.

This configuration includes further displaying the text information available to identify each of the persons, and thus enables recognition of contents of the utterances of the persons at a photographing spot for an image by using the text information.

Moreover, the disclosure can be realized as: the information processing method executing the above-described distinctive ways; and a information processing device including each distinctive feature corresponding to the distinctive ways executed by the information processing method. Additionally, the disclosure can be realized by a computer program causing a computer to execute the distinctive ways included in the information processing method. From these perspectives, the same advantageous effects as those of the information processing method are achievable in the following other aspects.

(13) An information processing device according to another aspect of the present disclosure includes a processor. The processor is configured to: display a bird’s-eye view on a display of an information terminal; display, in the bird’s-eye view, a plurality of first icons respectively indicating a plurality of photographing spots in connection with photographing times;

acquire content information having been recorded; and display, in the bird’s-eye view, information showing association of the content information with a first icon having a photographing time that is closer to a recording time for the content information among the first icons.

(14) An information processing program according to another aspect of the present disclosure includes causing a computer to: display a bird’s-eye view on a display of an information terminal; display, in the bird’s-eye view, a plurality of first icons respectively indicating a plurality of photographing spots in connection with photographing times; acquire content information having been recorded; and display, in the bird’s-eye view, information showing association of the content information with a first icon having a photographing time that is closer to a recording time for the content information among the first icons.

(15) A non-transitory computer readable recording medium according to another aspect of the present disclosure stores an information processing program described in (14) above.

Embodiments of this disclosure will be described with reference to the accompanying drawings. Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

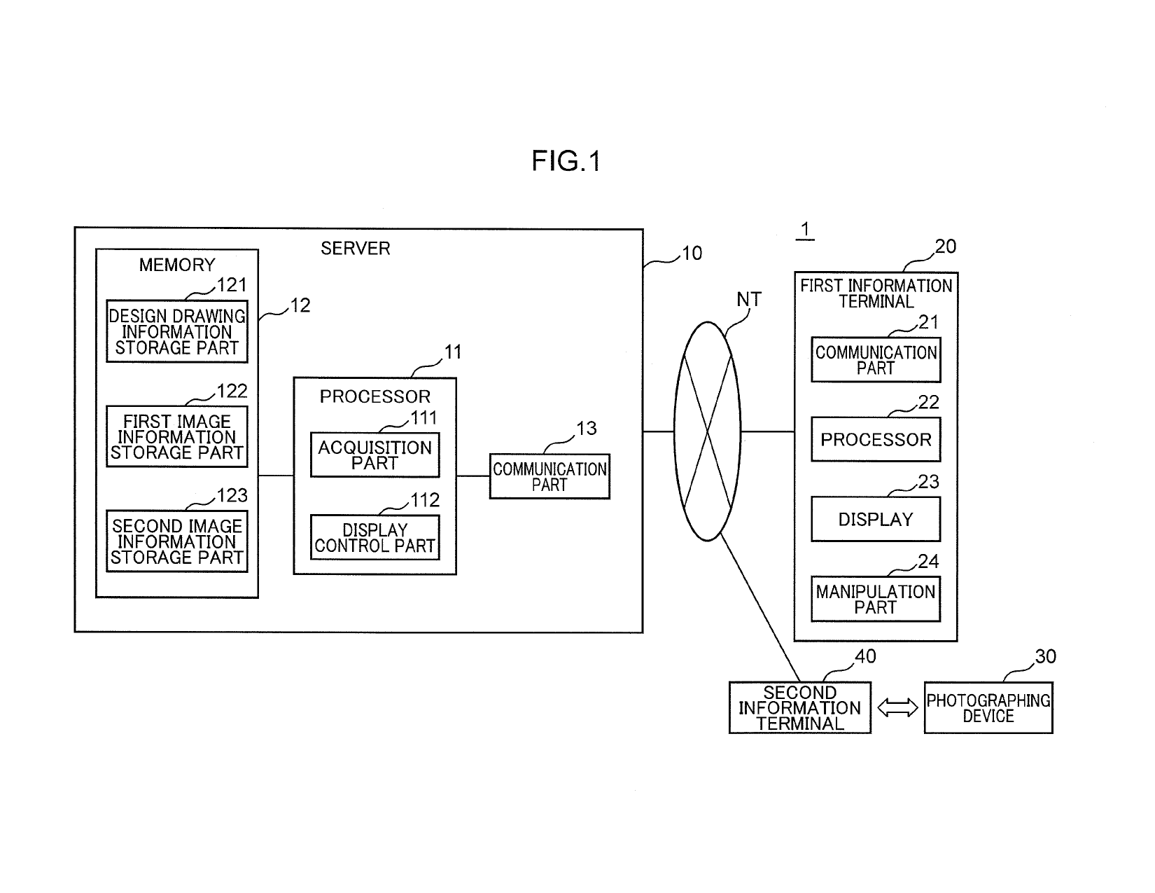

First embodiment FIG. 1 is diagram showing an overall configuration of an information processing system 1 in a first embodiment.

The information processing system 1 is configured to: display a bird’s-eye view; display, in the bird’s-eye view, a plurality of first icons respectively indicating a plurality of photographing spots in connection with photographing times; and display, in the bird’s-eye view, information showing association of content information with a first icon having a photographing time that is closer to a recording time for the content information among the first icons. The information processing system 1 includes a server 10, a first information terminal 20, a photographing device 30, and a second information terminal 40.

The server 10 is an example of an information processing device and a computer. The server 10, the first information terminal 20, and the second information terminal 40 are communicably connected to one another via a network NT. The network NT includes, for example, the internet. The server 10 includes, for example, a cloud server including one or more computers. However, this is a mere example, and the server 10 may include an edge server, or may be mounted to the first information terminal 20. A configuration in which the server 10 is mounted to the first information terminal 20 corresponds to an example configuration of the first information terminal 20 in the form of an information processing device.

The first information terminal 20 is carriable by a user. The user is, for example, a manager of a predetermined space to be photographed by the photographing device 30. The predetermined space is, for example, a construction site. However, this is a mere example, and the predetermined space may be a worksite, a factory, a shop or store, or an office. The first information terminal 20 may include a portable computer, e.g., a smartphone or a tablet computer, or may include a stationary computer. The first information terminal 20 is configured to display an image on a display 23 under control by the server 10. Although FIG. 1 shows an example of one first information terminal 20, a plurality of first information terminals may be connected to the server 10 via the network NT. The first information terminal 20 includes a communication part 21, a processor 22, the display 23, and a manipulation part 24.

The communication part 21 includes a communication interface that connects the first information terminal 20 to the network NT. The communication part 21 is configured to send, to the server 10, instruction signals respectively indicating various instructions which the manipulation part 24 receives from the user. The communication part 21 is configured to receive, from the server 10, display data to display various display screen images.

The processor 22 includes, for example, a central processing unit (CPU), and causes the display 23 to display a display screen image indicated by the display data received by the communication part 21.

The display 23 includes, for example, various display devices, e.g., liquid crystal displays or organic Electro-Luminescence (EL) displays, to display various display screen images under control by the processor 22.

The manipulation part 24 includes, for example, a keyboard, a touch screen, and a mouse, and is configured to receive various instructions input by the user.

The second information terminal 40 includes a mobile information terminal, e.g., a smartphone or a tablet computer, and connects the photographing device 30 to the network NT. The second information terminal 40 and the photographing device 30 are communicably connected to each other via a near field communication channel, such as the Bluetooth (registered trademark). The photographing device 30 is an example of a first photographing device, and the second information terminal 40 is an example of a second photographing device.

The photographing device 30 includes, for example, an omnidirectional camera, and captures a first image at a predetermined frame rate. The omnidirectional camera is also referred to as a 360-degree camera and can acquire an omnidirectional image at 360 degrees. The photographing device 30 is, for example, a portable photographing device carriable by a photographing person. The photographing person is, for example, a worker or a site supervisor on a construction site. The photographing device 30 may execute photographing in a state of being held in a hand of the photographing person or in a state of being attached to a body (e.g., the head) of the photographing person. The photographing device 30 may include a typical camera.

The photographing person moves on the construction site while photographing the construction site with the photographing device 30. The photographing person presses, at a photographing start spot, a photographing button of the photographing device 30 while making a photographing direction of the photographing device 30 agree with the north direction to start photographing, and presses the photographing button again to finish the photographing when reaching a photographing finish spot. When the photographing is finished, the photographing device 30 sends a series of first images having been captured to the second information terminal 40.

First, the photographing device 30 displays the photographing button to instruct start or stop of photographing and receives pressing of the photographing button by the photographing person. Next, the photographing device 30 determines whether the photographing button is pressed to instruct the start of the photographing. The photographing device 30 starts to capture a first image in response to pressing of the photographing button, and causes a memory provided inside to store the captured first image. Subsequently, the photographing device 30 determines whether the photographing button is pressed to instruct the stop of the photographing. The photographing device 30 stops storing of a subsequent first image in response to pressing of the photographing button and sends a plurality of first images stored in the memory provided inside to the second information terminal 40.

Each first image includes a photographing date and time. For instance, the photographing date and time is acquired by a timepiece included in the photographing device 30. Here, the photographing device 30 is configured to capture an image at a predetermined frame rate (e.g., ten frames per second), and therefore, a photographing spot is defined by a frame periodic unit. However, this leads to a huge amount of data, and thus, the photographing spot may be defined for a predetermined time period (e.g., one second, five seconds, or ten seconds).

The second information terminal 40 is configured to receive the first images sent from the photographing device 30. The second information terminal 40 is further configured to display a design drawing for the construction site, and receive designation by the photographing person about a position corresponding to the photographing start spot and a position corresponding to the photographing finish spot in the design drawing.

The photographing start spot and the photographing finish spot are specified in response to input of instruction from the photographing person to designate the position corresponding to each spot shown in a design drawing screen image of a site displayed on a display of the second information terminal 40. A two-dimensional coordinate axis is defined in the design drawing screen image. Thus, each of the photographing start spot and the photographing finish spot is defined by a two-dimensional coordinate value. The server 10 uses each of the photographing start spot and the photographing finish spot to specify a position corresponding to each photographing spot and a photographing direction for each image.

The second information terminal 40 sends, to the server 10 via the network NT, first photographing information including the captured first images. The first photographing information is generated at every execution of one photographing operation. The one photographing operation means a series of actions from start of photographing to finish of the photographing by a worker carrying the photographing device 30 on the construction site. A plurality of first images is captured through the one photographing operation. The first photographing information includes the captured first images and meta information about each of the first images. The meta information includes a photographing ID, a photographing date and time, and a design drawing ID. The photographing ID is an identifier to identify a photographing operation. The photographing date and time represents a photographing date and time for each first image. The design drawing ID is an identifier to identify a design drawing for a predetermined space corresponding to an image.

The second information terminal 40 includes a camera that is configured to capture a second image. The photographing person moves on the construction site while photographing the construction site with the photographing device 30. At this time, the photographing person photographs a desired place on the construction site independently with the camera included in the second information terminal 40. A processor included in the second information terminal 40 records the second image captured by the camera in a memory included in the second information terminal 40. The second image is an example of content information.

The second information terminal 40 is configured to send, to the server 10 via the network NT, second photographing information including the second image captured by the second information terminal 40 during capturing of the first images by the photographing device 30. The second photographing information includes at least one second image having been captured, and meta information about the at least one second image. The meta information includes a photographing ID and a photographing date and time. The photographing ID is an identifier to identify a photographing operation. The photographing ID is the same as the photographing ID associated with the first images. The photographing date and time represents a photographing date and time for the second image, and is acquired by, for example, a timepiece included in the second information terminal 40.

Although the camera included in the second information terminal 40 captures the second image in the first embodiment, the present disclosure is not particularly limited thereto. Another photographing device different from the photographing device 30 may capture a second image. The second information terminal 40 may be communicably connected to the another photographing device, receive the second image sent thereto from the another photographing device, and may send second photographing information including the received second image to the server 10.

The server 10 includes a processor 11, a memory 12, and a communication part 13. The processor 11 includes, for example, a central processing unit (CPU). The processor 11 includes an acquisition part 111 and a display control part 112. Each of the acquisition part 111 and the display control part 112 may come into effect, for example, when the processor 11 executes an information processing program, or may be established in the form of a dedicated hardware circuit, such as an application specific integrated circuit (ASIC). The information processing program may be recorded in a non-transitory computer-readable recording medium.

The communication part 13 includes a communication interface that connects the server 10 to the network NT. The communication part 13 is configured to receive the first photographing information sent from the second information terminal 40. The communication part 13 is configured to receive the second photographing information sent from the second information terminal 40. In this way, the communication part 13 acquires content information recorded by the second information terminal 40, that is, acquires the second image captured by the second information terminal 40. The communication part 13 is configured to receive from the first information terminal 20, instruction signals respectively indicating various instructions received from the user. The communication part 13 is configured to send to the first information terminal 20, display data to display various display screen images.

The memory 12 includes a non-volatile and rewritable storage device, such as a hard disk drive or a solid state drive. The memory 12 includes a design drawing information storage part 121, a first image information storage part 122, and a second image information storage part 123.

The design drawing information storage part 121 stores design drawing information. The design drawing information includes image information indicating a design drawing for a predetermined space. The design drawing information is associated with a design drawing ID to identify the design drawing. The design drawing is an example of a bird’s-eye view. The design drawing represents a drawing of a design for a construction site, and may include a plan view, a blueprint, a map, or a perspective view of the construction site. The bird’s-eye view can be rephrased as an overhead view, that is, a view seen from above, or a view from a high position looking down.

The processor 11 specifies, by employing the Visual Simultaneous Localization and Mapping (SLAM) technique, a position corresponding to a photographing spot for each of the first images from a photographing start spot, a photographing finish spot, and the first images each included in the first photographing information received by the communication part 13. Such a position corresponding to the photographing spot is expressed with a two-dimensional coordinate value in the design drawing. The processor 11 further specifies a photographing direction for each of the first images by employing the Visual SLAM technique. The photographing direction for each first image is expressed with, for example, a three-dimensional polar coordinate vector.

The processor 11 is configured to generate first image information on the basis of the first photographing information received by the communication part 13, and cause the first image information storage part 122 to store the generated first image information.

The first image information storage part 122 stores the first image information. The first image information associates the first images captured by the photographing device 30 at a plurality of photographing spots and meta information about each of the first images with each other. The first image information is generated at every receipt of the first photographing information. The meta information includes a photographing ID, a photographing date and time, a photographing direction, a photographing spot, and a design drawing ID. The photographing direction represents a photographing direction in which the photographing device 30 has captured each first image. The photographing spot indicates positional information (a two-dimensional coordinate value) indicating the photographing spot for each first image.

The processor 11 is configured to generate second image information on the basis of the second photographing information received by the communication part 13, and cause the second image information storage part 123 to store the generated second image information.

The second image information storage part 123 stores the second image information. The second image information associates at least one second image captured by the second information terminal 40 and meta information about the at least one second image with each other. The second image information is generated at every receipt of the second photographing information. The meta information includes a photographing ID and a photographing date and time.

The communication part 13 is configured to receive an instruction to display a design drawing from the first information terminal 20. The manipulation part 24 of the first information terminal 20 receives selection of the design drawing by the user, and the communication part 21 sends, to the server 10, an instruction to display the design drawing selected by the user. The instruction to display the design drawing includes a design drawing ID.

The communication part 13 is configured to receive an instruction to designate a photographing date and time from the first information terminal 20. The manipulation part 24 of the first information terminal 20 receives selection of the photographing date and time by the user, and the communication part 21 sends, to the server 10, an instruction to designate the photographing date and time selected by the user. The instruction to designate the photographing date and time contains a photographing ID.

The acquisition part 111 acquires from the design drawing information storage part 121, a design drawing corresponding to the design drawing ID contained in the instruction to display the design drawing received by the communication part 13. Moreover, the acquisition part 111 acquires from the first image information storage part 122, a plurality of photographing spots corresponding to the photographing ID contained in the instruction to designate the photographing date and time received by the communication part 13. The acquisition part 111 is further configured to acquire, from the first image information storage part 122, a plurality of photographing dates and times for a plurality of first images corresponding to the photographing ID, and acquire, from the second image information storage part 123, a photographing date and time for a second image corresponding to the photographing ID.

The display control part 112 is configured to cause the display 23 of the first information terminal 20 to display a design drawing for a workspace. The display control part 112 causes the display 23 of the first information terminal 20 to display the design drawing acquired by the acquisition part 111. The display control part 112 is configured to send display data for the design drawing to the first information terminal 20 via the communication part 13. The communication part 21 of the first information terminal 20 receives the display data sent from the server 10. The display 23 displays the design drawing received by the communication part 21.

The display control part 112 is configured to display, in the design drawing, a plurality of first icons respectively indicating a plurality of photographing spots in connection with photographing times. The first icons are respectively associated with a plurality of first images captured by the photographing device 30 at the photographing spots.

The display control part 112 is configured to display, in the design drawing, information showing association of content information with a first icon having a photographing time that is closer to a recording time for the content information among the first icons. In the first embodiment, the photographing time represents a photographing date and time for each first image, the content information includes a second image captured by the second information terminal 40 during capturing of the first images by the photographing device 30, and the recording time represents a photographing date and time for the second image. The information showing association of the second image with the first icon constitutes a second icon different from the first icons. That is to say, the display control part 112 is configured to display, in the design drawing, the second icon showing association of the second image with a first icon having a photographing date and time that is closer to the photographing date and time for the second image among the first icons.

Here, a process by the second information terminal 40 in the first embodiment will be described.

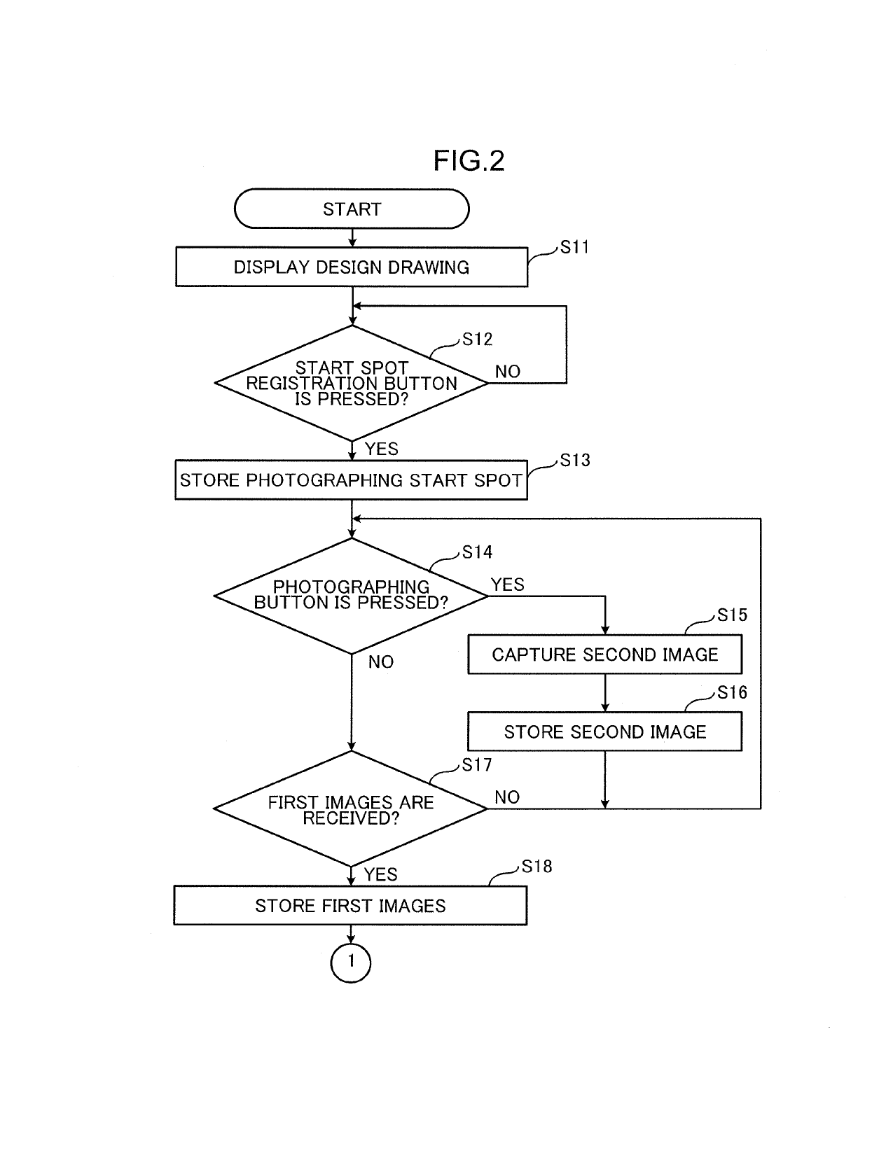

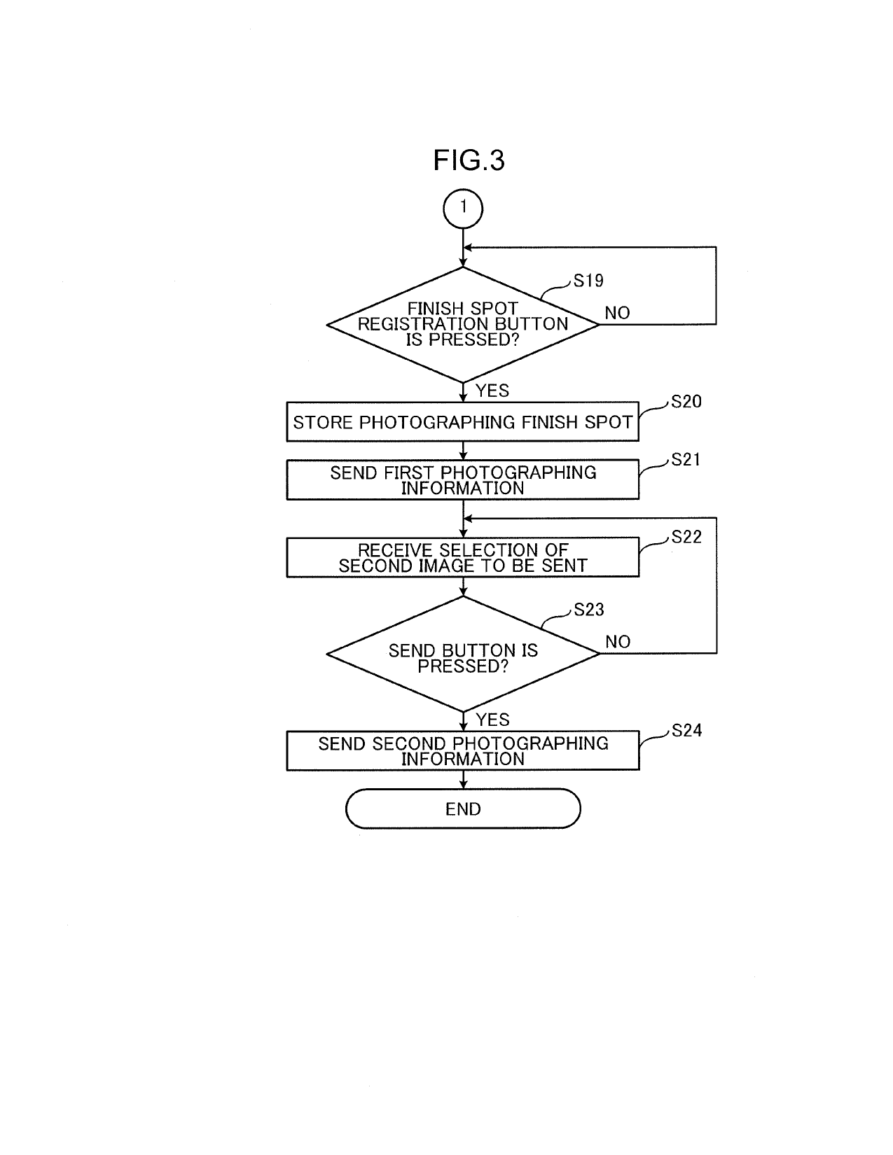

FIG. 2 is a first flowchart showing an example of the process by the second information terminal 40 in the first embodiment. FIG. 3 is a second flowchart showing an example of the process by the second information terminal 40 in the first embodiment.

First, in step S11, the second information terminal 40 displays a design drawing selected by a photographing person. At this time, the second information terminal 40 receives the selection of the design drawing by the photographing person.

Subsequently, in step S12, the second information terminal 40 determines whether a start spot registration button is pressed. At this time, the second information terminal 40 displays the start spot registration button together with the design drawing. The second information terminal 40 receives input of a start spot position in the design drawing by the photographing person, and receives pressing of the start spot registration button by the photographing person. For instance, the photographing person touches the start spot position in the design drawing being displayed. In this way, the start spot position is input. Then, the photographing person presses the start registration button.

The photographing person presses the photographing button of the photographing device 30, after pressing the start spot registration button, to start photographing for a first image with the photographing device 30.

When it is determined that the start spot registration button is not pressed (NO in step S12), step S12 is repeated.

In contrast, when it is determined that the start spot registration button is pressed (YES in step S12), the second information terminal 40 stores, in step S13, a photographing start spot shown in the design drawing. The second information terminal 40 stores a coordinate of the photographing start spot shown in the design drawing.

Next, in step S14, the second information terminal 40 determines whether the photographing button is pressed. After the start spot registration button is pressed, the second information terminal 40 displays the photographing button to receive photographing for a second image.

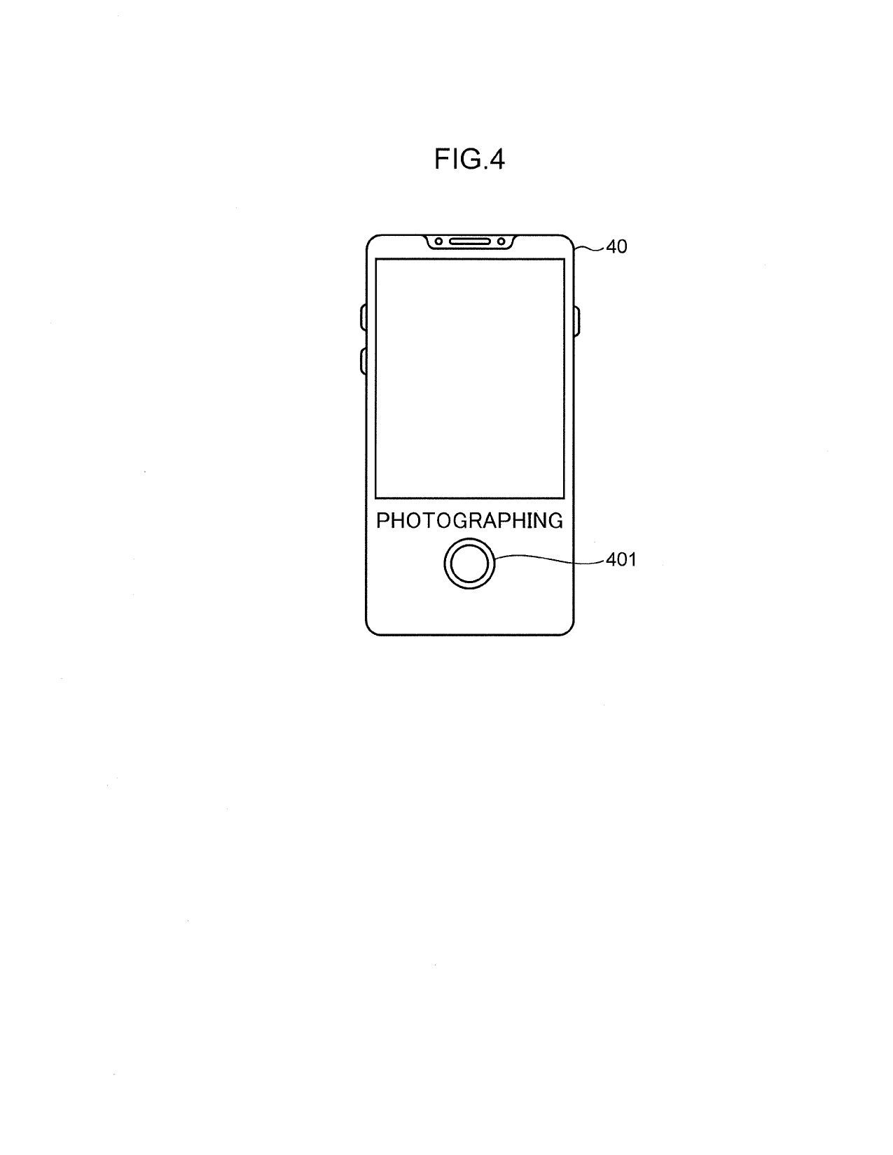

FIG. 4 illustrates an example display screen image to be displayed on the second information terminal 40 when a second image is captured.

As illustrated in FIG. 4, a photographing button 401 is displayed in the display screen image of the second information terminal 40. The photographing person presses the photographing button 401 when the photographing person encounters a certain place that the photographing person wishes to photograph independently during movement while performing photographing with the photographing device 30.

Referring back to FIG. 2, when it is determined that the photographing button is pressed (YES in step S14), the second information terminal 40 captures a second image in step S15.

Then, in step S16, the second information terminal 40 stores the second image. Thereafter, the process returns to step S14.

In contrast, when it is determined that the photographing button is not pressed (NO in step S14), the second information terminal 40 determines, in step S17, whether a plurality of first images is received from the photographing device 30. The photographing person presses the photographing button of the photographing device 30 again to finish the photographing when reaching a photographing finish spot. When the photographing button is pressed, the photographing device 30 sends the captured first images to the second information terminal 40.

When it is determined that a plurality of first images is not received from the photographing device 30 (NO in step S17), the process returns to step S14.

In contrast, when it is determined that a plurality of first images is received from the photographing device 30 (YES in step S17), the second information terminal 40 stores the received first images in step S18.

Subsequently, in step S19, the second information terminal 40 determines whether a finish spot registration button is pressed. At this time, the second information terminal 40 displays the finish spot registration button together with the design drawing. The second information terminal 40 receives input of a finish spot position in the design drawing by the photographing person, and receives pressing of the finish spot registration button by the photographing person. For instance, the photographing person touches the finish spot position in the design drawing being displayed. In this way, the finish spot position is input. Then, the photographing person presses the finish spot registration button.

When it is determined that the finish spot registration button is not pressed (NO in step S19), step S19 is repeated.

In contrast, when it is determined that the finish spot registration button is pressed (YES in step S19), the second information terminal 40 stores, in step S20, a photographing finish spot shown in the design drawing. The second information terminal 40 stores a coordinate of the photographing finish spot shown in the design drawing.

Then, in step S21, the second information terminal 40 sends first photographing information including the first images to the server 10.

Next, in step S22, the second information terminal 40 receives selection of a second image to be sent to the server 10. The photographing person may perform photographing for a plurality of second images during movement in some cases. In such a case where a plurality of second images is captured, the photographing person selects a second image to be sent to the server 10 from among the second images captured during the movement.

Subsequently, in step S23, the second information terminal 40 determines whether a send button is pressed. The second information terminal 40 receives the selection by the photographing person about the second image to be sent, and receives pressing of the send button by the photographing person. Then, the photographing person presses the send button after selecting the second image to be sent.

When it is determined that the send button is not pressed (NO instep S23), the process returns to step S22.

In contrast, when it is determined that the send button is pressed (YES in step S23), the second information terminal 40 sends, in step S24, second photographing information including selected at least one second image to the server 10.

When no second image is captured during capturing of the first images by the photographing device 30, step S22 to step S24 may not be executed. Furthermore, in a case where a second image is captured during capturing of the first images by the photographing device 30 but the second image is not selected, second photographing information may not be sent. Although step S22 to step S24 are continuously executed in time-series after execution of step S21 in the first embodiment, the present disclosure is not particularly limited thereto. Step S22 to step S24 may be executed after a lapse of certain time from the execution of step S21.

Next, a process by the server 10 in the first embodiment will be described.

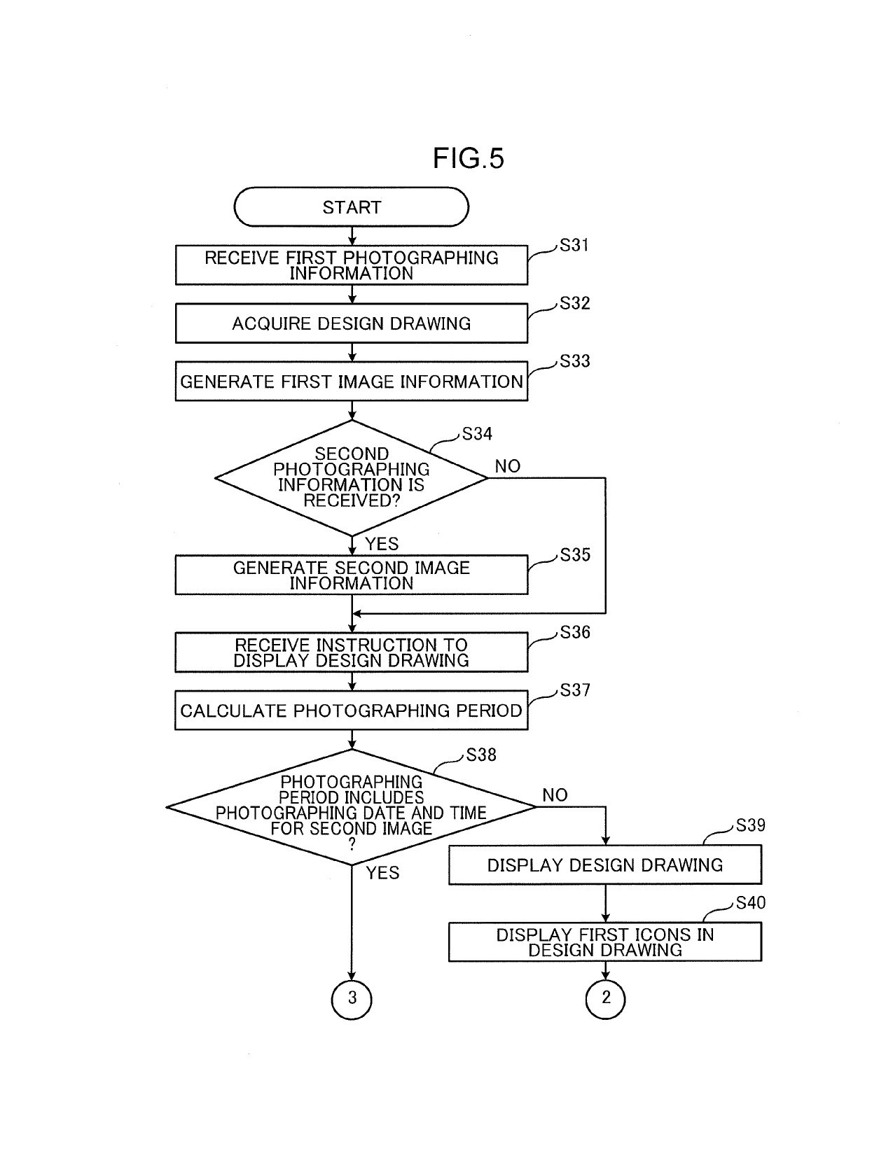

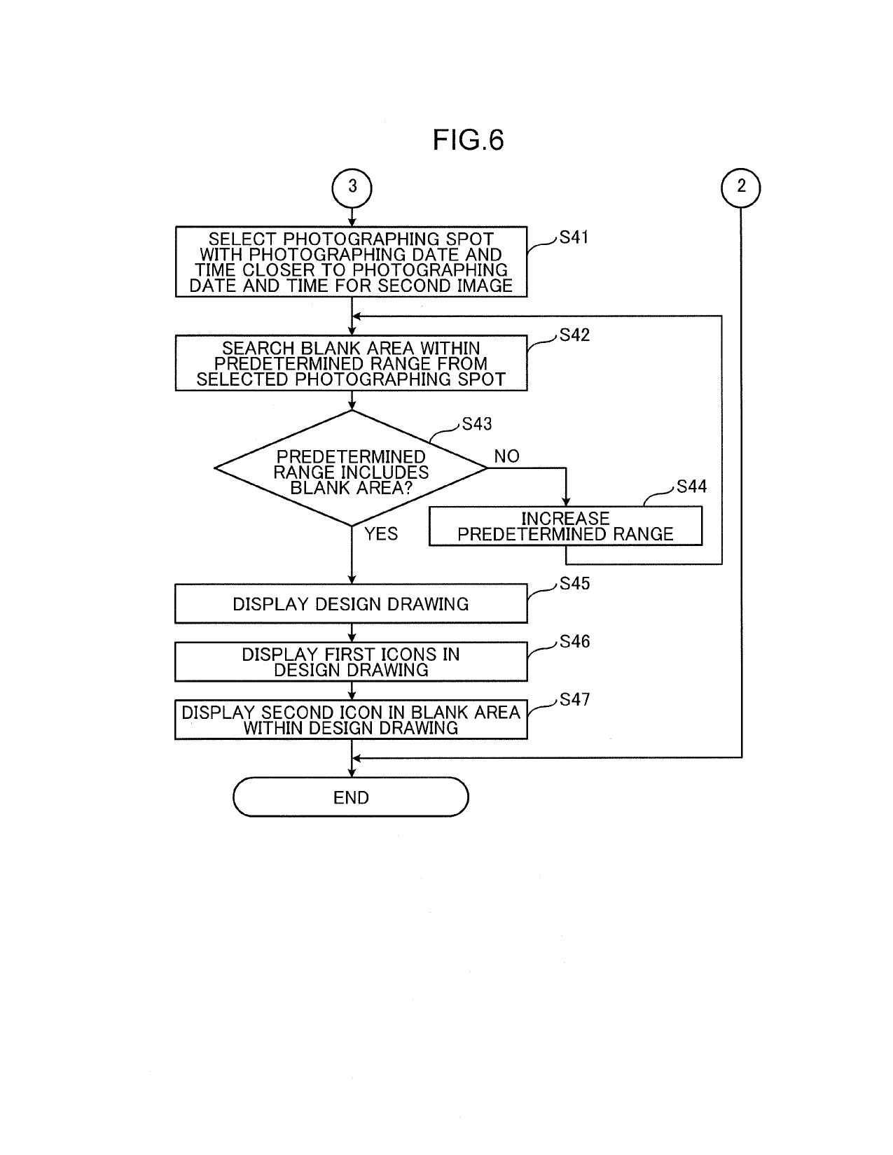

FIG. 5 is a first flowchart showing an example of the process by the server 10 in the first embodiment. FIG. 6 is a second flowchart showing an example of the process by the server 10 in the first embodiment.

First, in step S31, the communication part 13 receives the first photographing information sent from the second information terminal 40.

Subsequently, in step S32, the acquisition part 111 acquires a design drawing from the design drawing information storage part 121. The acquisition part 111 is configured to read out, from the design drawing information storage part 121, such a design drawing corresponding to a design drawing ID included in the first photographing information received by the communication part 13.

Then, in step S33, the acquisition part 111 generates first image information on the basis of the first photographing information and the design drawing. The acquisition part 111 calculates a photographing spot and a photographing direction shown in the design drawing for each of a plurality of first images by employing the Visual SLAM technique. The first image information associates the first images and meta information about each of the first images with each other. The meta information includes a photographing ID, a photographing date and time, a photographing direction, a photographing spot, and a design drawing ID. The acquisition part 111 stores the generated first image information in the first image information storage part 122.

Next, in step S34, the acquisition part 111 determines whether the communication part 13 receives second photographing information.

When it is determined that the communication part 13 receives no second photographing information (NO in step S34), the process proceeds to step S36.

In contrast, when it is determined that the communication part 13 receives second photographing information (YES in step S34), the acquisition part 111 generates, in step S35, second image information on the basis of the second photographing information received by the communication part 13. The second image information associates at least one second image and meta information about the at least one second image with each other. The meta information includes a photographing ID and a photographing date and time. The acquisition part 111 stores the generated second image information in the second image information storage part 123.

Subsequently, in step S36, the communication part 13 receives an instruction to display the design drawing from the first information terminal 20. In this case, the display 23 of the first information terminal 20 displays a menu screen image for design drawing selection, and the manipulation part 24 receives an instruction from the user to select one design drawing from the menu screen image. Moreover, the display 23 of the first information terminal 20 displays a menu screen image for photographing ID (photographing date and time) selection, and the manipulation part 24 receives an instruction from the user to select one photographing ID (photographing date and time) from the menu screen image. The instruction input in this manner is sent to the server 10 via the network NT and received by the communication part 13. The instruction to display the design drawing contains a design drawing ID and the photographing ID.

Then, in step S37, the display control part 112 calculates a photographing period being a period from a photographing date and time at an initial photographing spot (photographing start spot) to a photographing date and time at a final photographing spot (photographing finish spot) among photographing dates and times for the first images.

Next, in step S38, the display control part 112 determines whether the photographing period includes a photographing date and time for the second image. When it is determined that the photographing period includes no photographing date and time for the second image (NO in step S38), the display control part 112 sends display data for the design drawing to the first information terminal 20 via the communication part 13, and then causes the display 23 of the first information terminal 20 to display the design drawing, in step S39.

Subsequently, in step S40, the display control part 112 sends, to the first information terminal 20 via the communication part 13, a display instruction to display, in the design drawing, a plurality of first icons respectively indicating a plurality of photographing spots, and then displays, in the design drawing being displayed on the display 23 of the first information terminal 20, the first icons respectively indicating the photographing spots.

In contrast, when it is determined that the photographing period includes a photographing date and time for the second image (YES in step S38), the display control part 112 selects, in step S41, a photographing spot with a photographing date and time that is closer to the photographing date and time for the second image. The display control part 112 selects a photographing spot with a photographing date and time that is the same as the photographing date and time for the second image. When there is no photographing spot with a photographing date and time that is the same as the photographing date and time for the second image, the display control part 112 selects a photographing spot with a photographing date and time that is closest to the photographing date and time for the second image.

Then, in step S42, the display control part 112 searches, within a predetermined range from the selected photographing spot, a blank area available to display a second icon. The predetermined range indicates, for example, an encircled range having a predetermined radius from the selected photographing spot serving as the center.

Subsequently, in step S43, the display control part 112 determines whether the predetermined range includes such a blank area.

When it is determined that the predetermined range includes no blank area (NO in step S43), the display control part 112 increases the predetermined range in step S44. Thereafter, the process returns to step S42, and the display control part 112 repeats step S42 to step S44 until a blank area is found.

In contrast, when it is determined that the predetermined range includes a blank area (YES in step S43), the display control part 112 sends display data for a design drawing to the first information terminal 20 via the communication part 13, and then causes the display 23 of the first information terminal 20 to display the design drawing, in step S45.

Then, in step S46, the display control part 112 sends, to the first information terminal 20 via the communication part 13, a display instruction to display, in the design drawing, a plurality of first icons respectively indicating a plurality of photographing spots, and then displays, in the design drawing being displayed on the display 23 of the first information terminal 20, the first icons respectively indicating the photographing spots.

Next, in step S47, the display control part 112 sends, to the first information terminal 20 via the communication part 13, a display instruction to display, in the blank area within the design drawing, a second icon showing association of the second image with a first icon having a photographing date and time that is closer to a photographing date and time for the second image among the first icons, and then displays the second icon in the blank area within the design drawing.

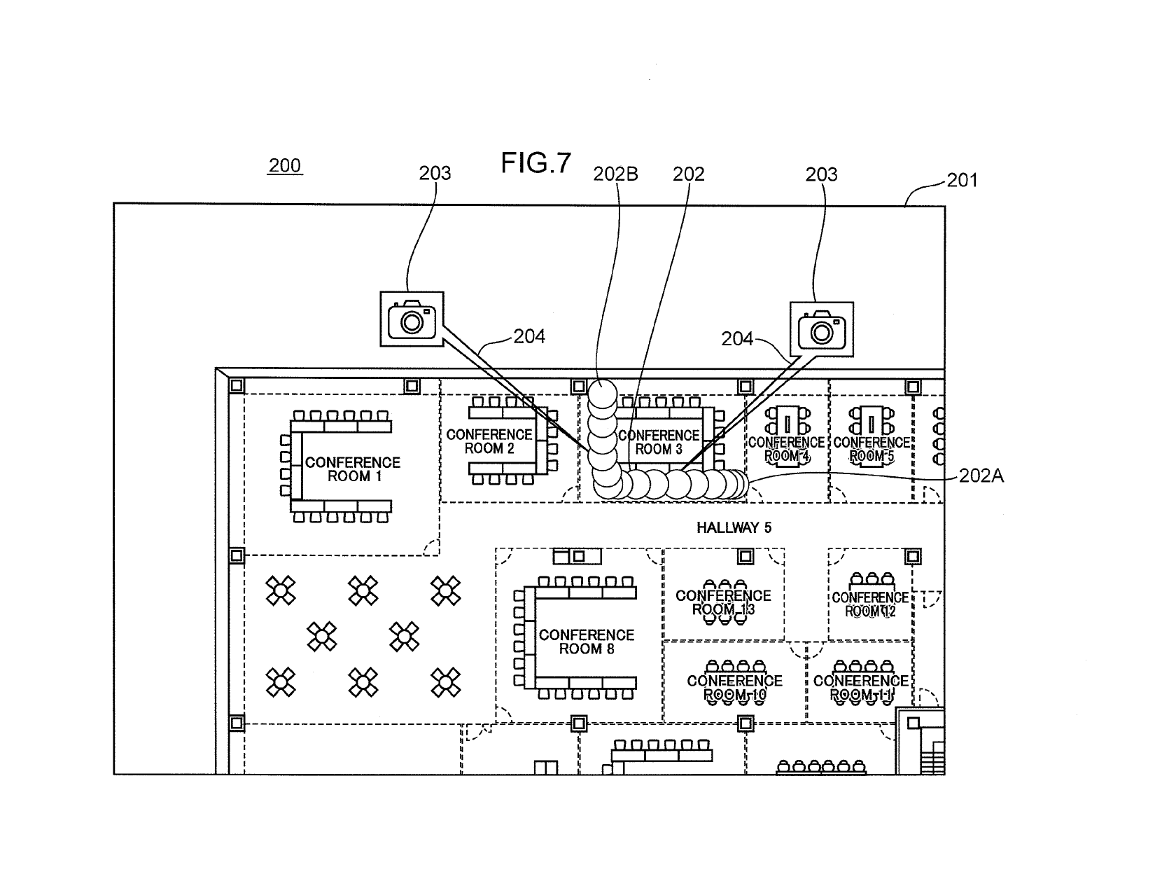

FIG. 7 illustrates an example design drawing screen image 200 displayed on the first information terminal 20 in the first embodiment.

The design drawing screen image 200 shows a design drawing 201 for a workspace. In the design drawing screen image 200, a plurality of first icons 202 is superimposed and displayed. Further, the design drawing screen image 200 shows, in a blank area within the design drawing 201, a second icon 203 showing association of a second image with a first icon 202 having a photographing date and time that is closer to a photographing date and time for the second image among the first icons 202. For instance, the second icon 203 has a quadrangular shape and includes an image imitating a camera.

Each first icon 202 indicates a photographing spot. The first icon 202 is associated with an image captured at the photographing spot. In this example, the first icon 202 includes an image having a circular shape. The shape of the first icon 202 is a mere example and may be another shape. The first icons 202 displayed here respectively correspond to a plurality of photographing spots belonging to one certain photographing operation. A route from a first icon 202A at a photographing start spot to a first icon 202B at a photographing finish spot shows a trace followed by the photographing person in the photographing operation.

Each first icon 202 is associated with a first image captured at a corresponding photographing spot. The manipulation part 24 may receive selection of one first icon 202 by the user from among the first icons 202. When the one first icon 202 is selected from among the first icons 202, the display control part 112 may read out, from the first image information storage part 122, a first image corresponding to the selected first icon 202, and cause the display 23 to display the read out first image.

The display control part 112 is configured to display the second icon at such a position as to avoid overlapping a character or a shape in the design drawing 201. The display control part 112 may be configured to display the second icon 203 in a blank area inside a building shown in the design drawing 201, in a blank area outside the building shown in the design drawing 201, or in an area expect for a region including the first icons 202 in the design drawing 201.

The display control part 112 is configured to associate the second icon 203 and the first icon 202 with each other by an outline 204 defining a predetermined shape. The display control part 112 connects the second icon 203 and the first icon 202 to each other by the outline 204 defining the predetermined shape. The predetermined shape is, for example, a triangular shape. A leading end of the outline 204 may meet a boundary of the first icon 202. The outline 204 may be displayed to show a correlation between the first icon 202 and the second icon 203. For instance, the leading end of the outline 204 may be located inside the boundary of a circular image of the first icon 202 or may be located within a preset extent outside the boundary of the circular image of the first icon 202.

Each of the first icons 202 is associated with a photographing direction in which the photographing device 30 has captured an image at each of the photographing spots. A certain point on the boundary of the first icon 202 is specified by the photographing direction associated with the first icon 202, and is connected to the outline 204. A position of the leading end of the outline 204 extending from the second icon 203 to the first icon 202 denotes a photographing direction associated with the first icon 202. Specifically, the outline 204 is displayed so that an intersection of a straight line extending from the center of the circular image of the first icon 202 in the photographing direction associated with the first icon 202 and the boundary of the circular image of the first icon 202 meets a vertex of the outline 204 defining a triangular shape and extending from the second icon 203. The user can know the photographing direction associated with the first icon 202 by confirming where the leading end of the outline 204 is located on the boundary of the circular image of the first icon 202. This allows the user to confirm the photographing direction in which each of the first image and the second images has been captured.

The second icon 203 is associated with the second image captured by the second information terminal 40. The manipulation part 24 may receive selection of the second icon 203 by the user. When the second icon 203 is selected, the display control part 112 may read out a second image corresponding to the selected second icon 203 from the second image information storage part 123, and cause the display 23 to display the read out second image.

In a case where a plurality of second images is associated with a photographing ID, the display control part 112 may display, in the design drawing 201, a plurality of second icons 203 respectively indicating a plurality of photographing spots for the second images. The display control part 112 may further connect each first icon 202 and each second icon 203 to each other with a straight line.

Although the display control part 112 is configured to display the second icon 203 differently from the first icons 202 in the first embodiment, the present disclosure is not particularly limited thereto. The display control part 112 may be configured to display a first icon having a photographing date and time that is closer to a photographing date and time for the second image differently from another first icon. In this case, the display control part 112 may differentiate a color of the first icon having the photographing date and time that is closer to the photographing date and time for the second image from a color of another first icon, or may differentiate a shape of the first icon having the photographing date and time that is closer to the photographing date and time for the second image from a shape of another first icon.

Conclusively, this configuration includes displaying, in the design drawing 201, the first icons 202 respectively indicating the photographing spots for the first images captured by the photographing device 30, and the second icon 203 indicating the photographing spot for the second image captured by the second information terminal 40 during capturing of the first images. The configuration thus allows the user to know the presence of the second image captured at a photographing spot for a certain first image from another viewpoint different from a viewpoint of the first image. The configuration further allows the user to save the time for sorting the second image captured independently of the first images, and then achieves improvement in the convenience for the user.

Moreover, this configuration allows the user to be notified of the presence of content information having been recorded, in addition to the image captured at the photographing spot, and achieves a reduction in the number of processing steps for access to the content information. The configuration that allows the user to be notified of the presence of the content information having been recorded, in addition to the image captured at the photographing spot, further achieves a reduction in the number of processing steps required by a computer for access to the content information, and hence achieves a reduction in the burden on the computer.

Second embodiment In the first embodiment, a second image captured by the second information terminal 40 during capturing of a plurality of first images by the photographing device 30 is acquired. In contrast, in a second embodiment, sound information recorded by a second information terminal 40A during capturing of a plurality of first images by a photographing device 30 is acquired.

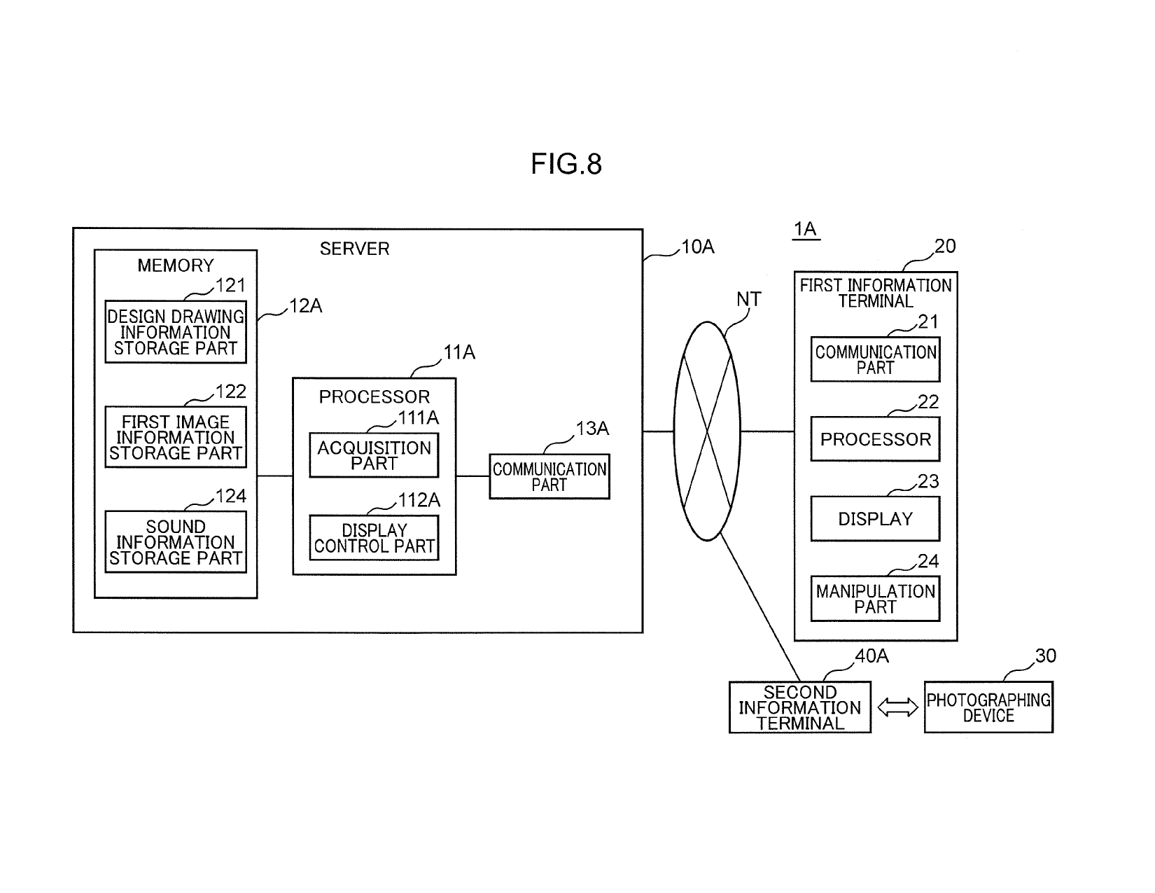

FIG. 8 is a diagram showing an overall configuration of an information processing system 1A in the second embodiment.

The information processing system 1A includes a server 10A, a first information terminal 20, the photographing device 30, and the second information terminal 40A. In the second embodiment, elements which are the same as those in the first embodiment are given the same reference signs and numerals, and thus, the descriptions therefor will be omitted. Further, in a configuration of the second embodiment, the descriptions for the operability or function which is the same as that in the first embodiment will be also omitted.

The second information terminal 40A includes a mobile information terminal, e.g., a smartphone or a tablet computer, and connects the photographing device 30 to a network NT. The second information terminal 40A and the photographing device 30 are communicably connected to each other via a near field communication channel, such as the Bluetooth (registered trademark). The photographing device 30 is an example of a photographing device, and the second information terminal 40A is an example of a sound recording device.

The second information terminal 40A is configured to receive the first images sent from the photographing device 30. The second information terminal 40A is configured to send, to the server 10A via the network NT, first photographing information including the captured first images.

The second information terminal 40A further includes a microphone that collects sound or voice therearound. A photographing person moves on a construction site while photographing the construction site with the photographing device 30. At this time, the photographing person makes an utterance at a desired place on the construction site. The microphone included in the second information terminal 40A is configured to collect a voice of the photographing person. A processor included in the second information terminal 40A records sound information collected by the microphone in a memory included in the second information terminal 40A. The sound information is an example of content information.

The second information terminal 40A is configured to send, to the server 10A via the network NT, sound recording information including the sound information recorded by the second information terminal 40A during capturing of the first images by the photographing device 30. The sound recording information includes at least one piece of sound information having been recorded, and meta information about the at least one piece of sound information. The meta information includes a photographing ID, a sound recording start date and time, and a sound recording finish date and time. The photographing ID is an identifier to identify a photographing operation. The photographing ID is the same as the photographing ID associated with the first images. The sound recording start date and time represents a date and time when sound recording of sound information is started, and the sound recording finish date and time represents a date and time when the sound recording of the sound information is finished. Each of the sound recording start date and time and the sound recording finish date and time is acquired by, for example, a timepiece included in the second information terminal 40A.

Although the microphone included in the second information terminal 40A collects a sound or voice in the second embodiment, the present disclosure is not particularly limited thereto. Another sound recording device different from the second information terminal 40A may collect a sound or voice. The second information terminal 40A may be communicably connected to the another sound recording device, receive sound information sent thereto from the another sound recording device, and send sound recording information including the received sound information to the server 10A. Alternatively, the photographing device 30 may include a sound recorder configured to record sound information. In this configuration, the sound recorder included in the photographing device 30 is an example of the sound recording device.

The server 10A includes a processor 11A, a memory 12A, and a communication part 13A. The processor 11A includes, for example, a central processing unit (CPU). The processor 11A includes an acquisition part 111A and a display control part 112A. Each of the acquisition part 111A and the display control part 112A may come into effect, for example, when the processor 11A executes an information processing program, or may be established in the form of a dedicated hardware circuit, such as an ASIC. The information processing program may be recorded in a non-transitory computer-readable recording medium.

The communication part 13A includes a communication interface that connects the server 10A to the network NT. The communication part 13A is configured to receive the first photographing information sent from the second information terminal 40A. The communication part 13A is configured to receive the sound recording information sent from the second information terminal 40A. In this way, the communication part 13A acquires content information recorded by the second information terminal 40A, that is, acquires the sound information recorded by the second information terminal 40A. The communication part 13A is configured to receive from the first information terminal 20, instruction signals respectively indicating various instructions received from a user. The communication part 13A is configured to send to the first information terminal 20, display data to display various display screen images.

The memory 12A includes a non-volatile and rewritable storage device, such as a hard disk drive or a solid-state drive. The memory 12A includes a design drawing information storage part 121, a first image information storage part 122, and a sound information storage part 124.

The sound information storage part 124 stores sound recording information including sound information. The sound recording information associates at least one piece of sound information collected by the second information terminal 40A and meta information about the at least one piece of sound information with each other. The sound recording information is stored at every receipt of the sound recording information. The meta information includes a photographing ID, a sound recording start date and time, and a sound recording finish date and time.

The acquisition part 111A is configured to acquire, from the first image information storage part 122, a plurality of photographing dates and times for a plurality of first images corresponding to the photographing ID, and acquire, from the sound information storage part 124, a sound recording start date and time for sound information corresponding to the photographing ID.

The display control part 112A is configured to display, in a design drawing, information showing association of content information with a first icon having a photographing time that is closer to a recording time for the content information among a plurality of first icons. In the second embodiment, the photographing time represents a photographing date and time for each first image, the content information includes sound information recorded by the second information terminal 40A during capturing of the first images by the photographing device 30, and the recording time represents a sound recording start date and time or a sound recording finish date and time for the sound information. The information showing association of the sound information with the first icon constitutes a second icon different from the first icons. That is to say, the display control part 112A is configured to display, in the design drawing, the second icon showing association of the sound information with a first icon having a photographing date and time that is closer to a recording start date and time for the sound information among the first icons.

Here, a process by the second information terminal 40A in the second embodiment will be described.

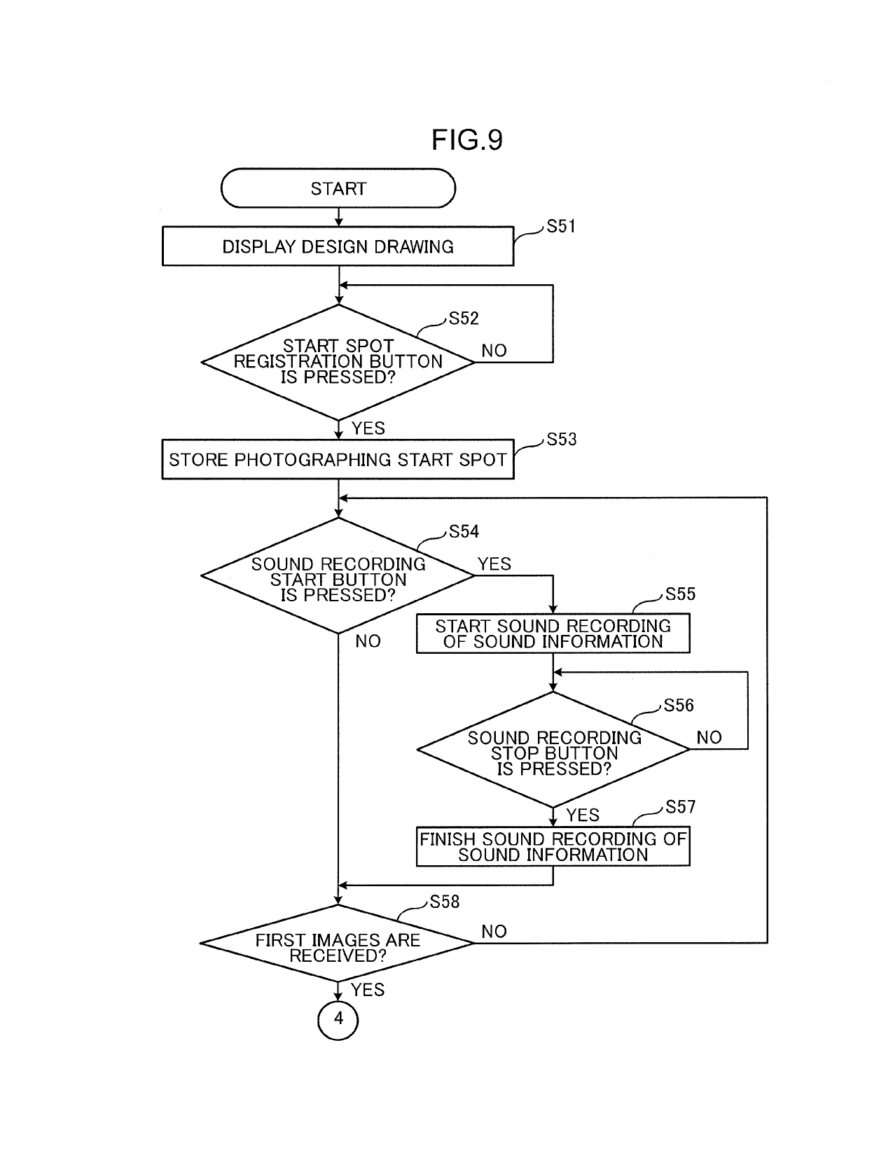

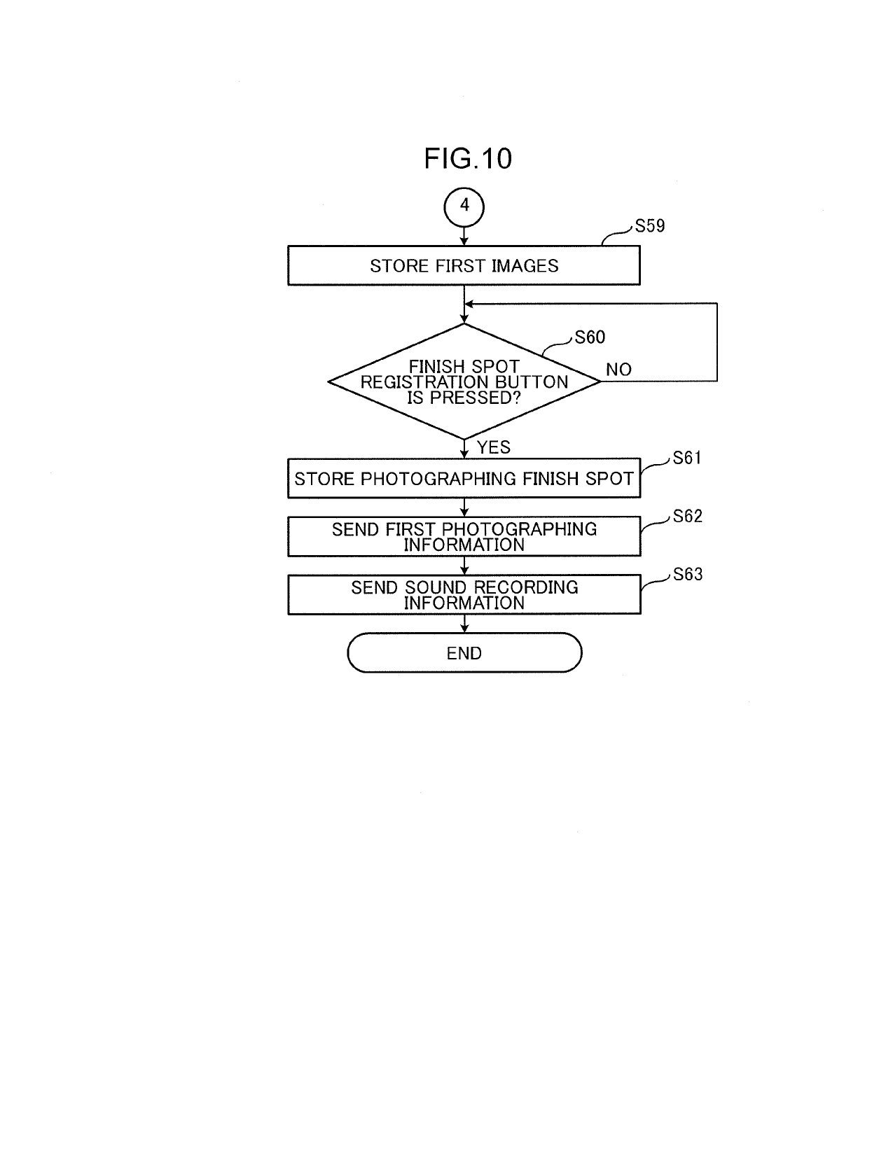

FIG. 9 is a first flowchart showing an example of the process by the second information terminal 40A in the second embodiment. FIG. 10 is a second flowchart showing an example of the process by the second information terminal 40A in the second embodiment.

Step S51 to step S53 are the same as step S11 to step S13 in FIG. 2, and thus, the descriptions therefor will be omitted.

Next, in step S54, the second information terminal 40A determines whether a sound recording start button is pressed. The second information terminal 40A displays the sound recording start button to receive start of sound recording after a start spot registration button is pressed.

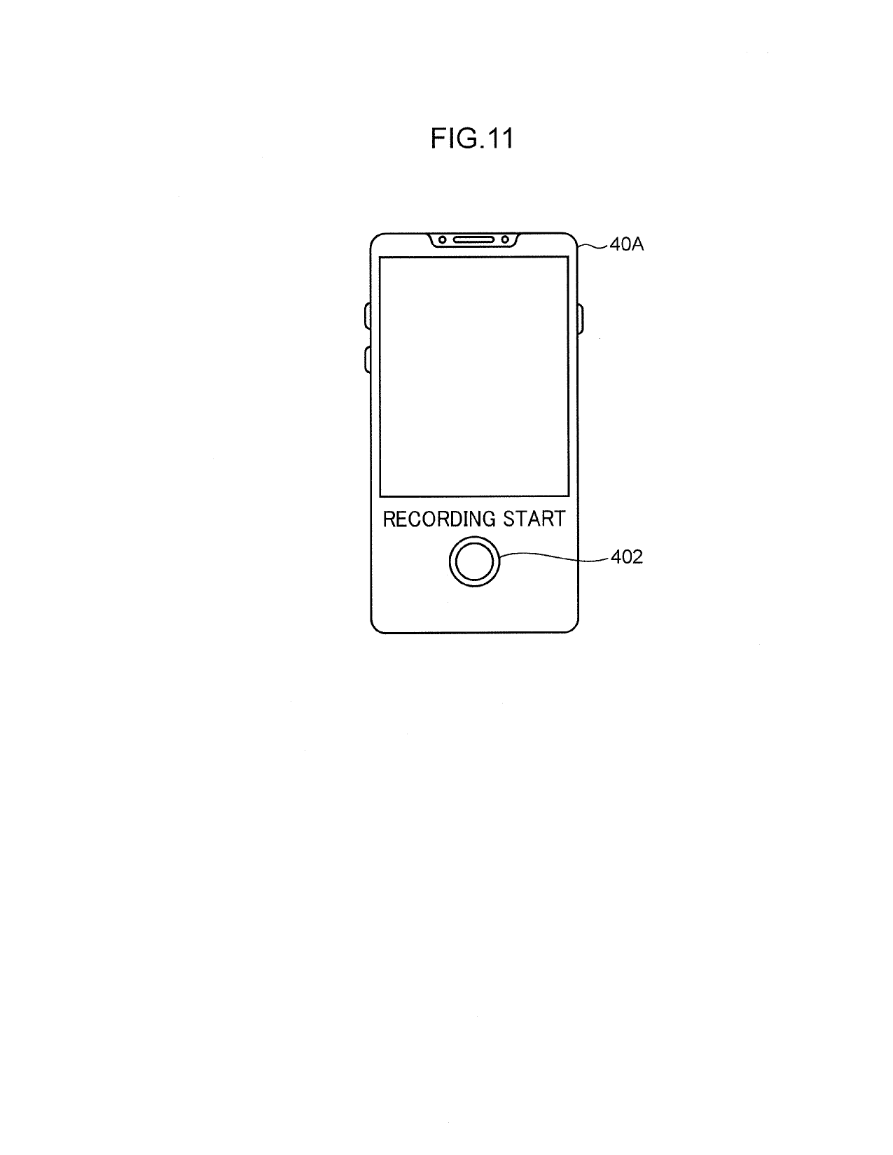

FIG. 11 illustrates an example display screen image to be displayed on the second information terminal 40A when sound recording is started in the second embodiment.

As illustrated in FIG. 11, a sound recording start button 402 is displayed in the display screen image of the second information terminal 40A. A photographing person presses the sound recording start button 402 when the photographing person wishes to record a sound or voice during movement while performing photographing with the photographing device 30. For instance, the photographing person presses the sound recording start button 402 and makes an utterance at a certain place for which the photographing person wishes to leave a comment while photographing the construction site. In this way, sound recording of an utterance content of the photographing person is started.

Referring back to FIG. 9, when it is determined that the sound recording start button is pressed (YES in step S54), the second information terminal 40A starts sound recording of sound information in step S55. The sound information is stored in a memory included in the second information terminal 40A.

Next, in step S56, the second information terminal 40A determines whether a sound recording stop button is pressed. After the sound recording start button is pressed, the second information terminal 40A displays the sound recording stop button to receive finish of the sound recording of the sound or voice.

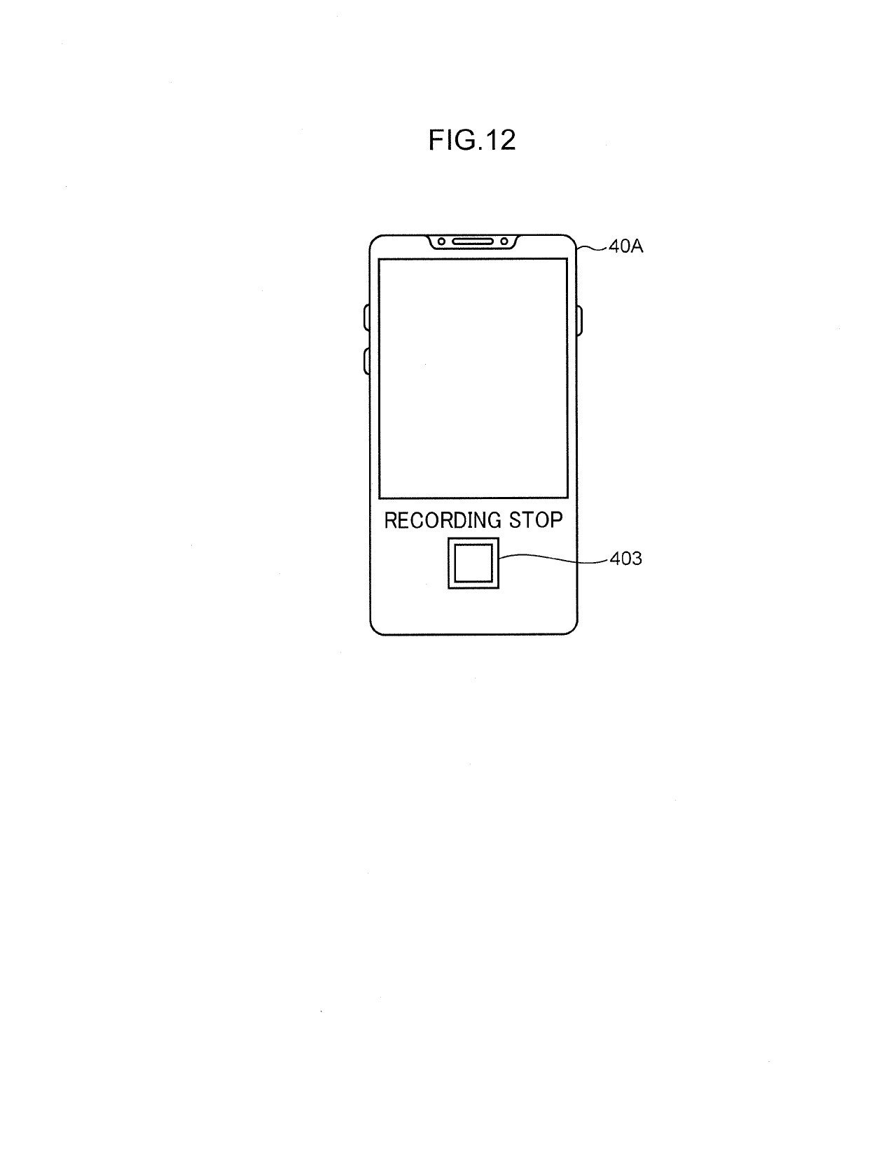

FIG. 12 illustrates an example display screen image to be displayed on the second information terminal 40A when the sound recording is finished in the second embodiment.

As illustrated in FIG. 12, a sound recording stop button 403 is displayed in the display screen image of the second information terminal 40A. The photographing person presses the sound recording stop button 403 to finish the sound recording. For instance, the photographing person presses the sound recording stop button 403 when finishing the utterance. In this way, the sound recording of the utterance content of the photographing person is finished, and the photographing person can leave a comment with a sound or voice concerning a photographing spot for a first image.

Referring back to FIG. 9, when it is determined that the sound recording stop button is pressed (YES in step S56), the second information terminal 40A finishes the sound recording of the sound information in step S57.

In contrast, when it is determined that the sound recording stop button is not pressed (NO in step S56), step S56 is repeated.

When the sound recording of the sound information is finished in step S57 or when it is determined that the sound recording start button is not pressed (NO in step S54), the second information terminal 40A determines, in step S58, whether a plurality of first images is received from the photographing device 30.

Step S58 to step S62 are the same as step S17 to step S21 in FIG. 2 and FIG. 3, and thus, the descriptions therefor will be omitted.

Subsequently, in step S63, the second information terminal 40A sends, to the server 10A, sound recording information including at least one piece of sound information.

The second information terminal 40A may receive selection of sound information to be sent to the server 10A in the second embodiment. The photographing person may perform sound recording of a plurality of pieces of sound information during movement in some cases. In such a case where a plurality of pieces of sound information is recorded, the photographing person may select sound information to be sent to the server 10A from among the pieces of sound information having been recorded during the movement. The second information terminal 40A may send, to the server 10A, sound recording information including selected at least one piece of sound information. Further, the selection of the sound information and the sending of the sound recording information may be executed after a lapse of certain time from execution of step S62. When no sound information is recorded during capturing of the first images by the photographing device 30, step S63 may not be executed.

Next, a process by the server 10A in the second embodiment will be described.

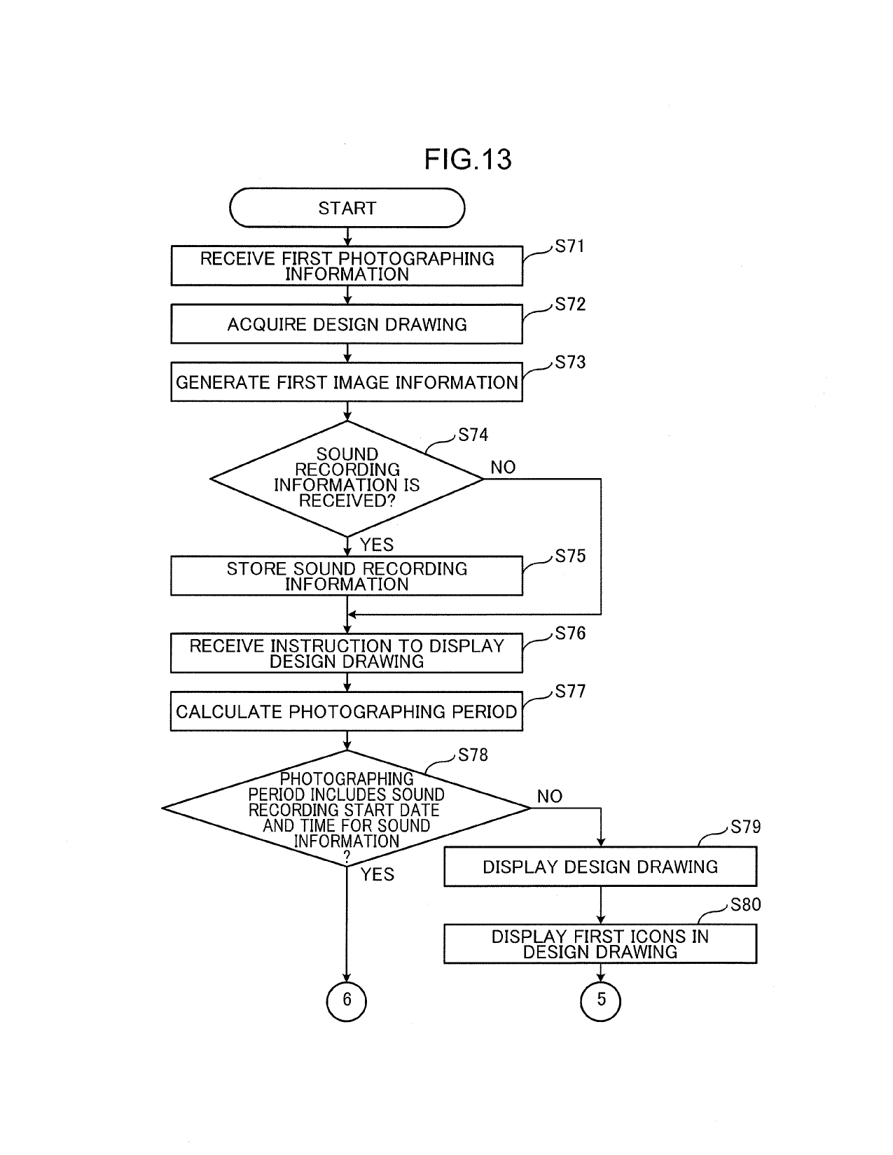

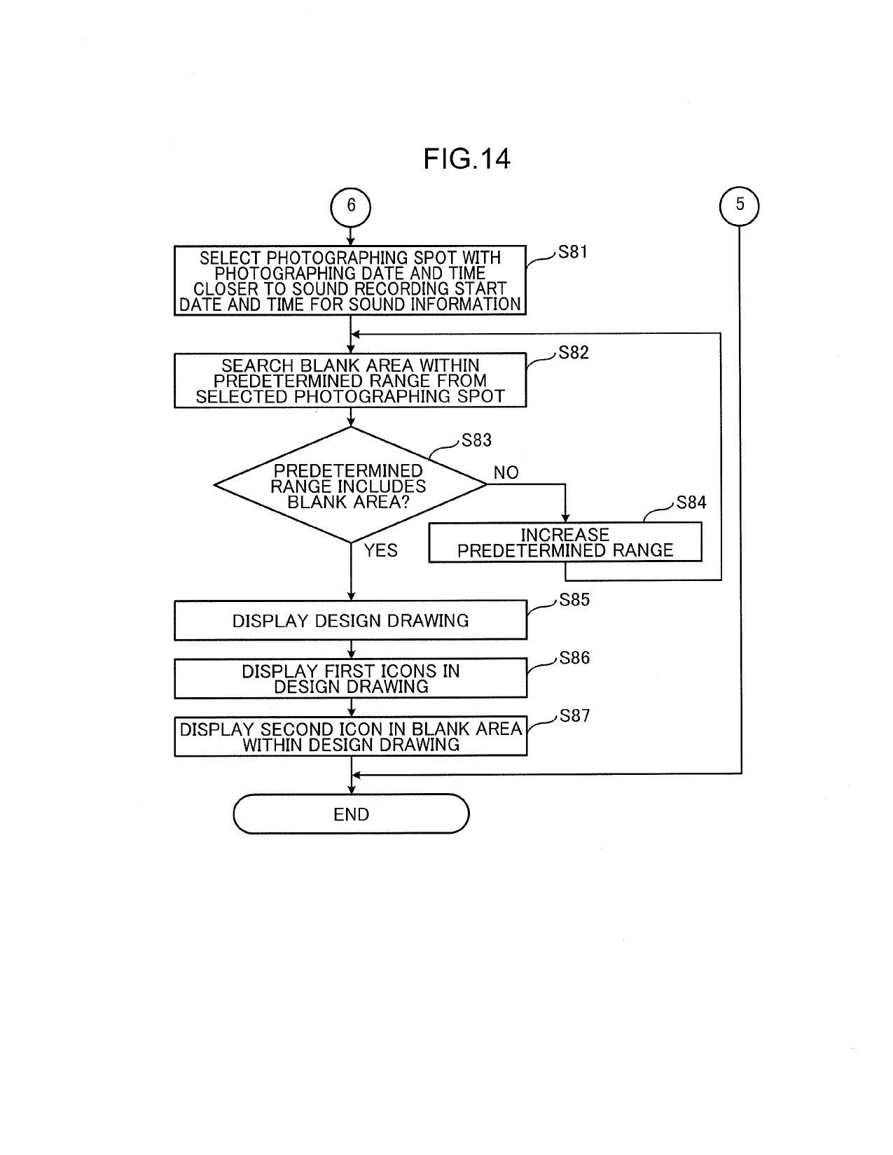

FIG. 13 is a first flowchart showing an example of the process by the server 10A in the second embodiment. FIG. 14 is a second flowchart showing an example of the process by the server 10A in the second embodiment.

Step S71 to step S73 are the same as step S31 to step S33 in FIG. 5, and thus, the descriptions therefor will be omitted.

Subsequently, in step S74, the acquisition part 111A determines whether the communication part 13A receives sound recording information.

When it is determined that the communication part 13A receives no sound recording information (NO in step S74), the process proceeds to step S76.

In contrast, when it is determined that the communication part 13A receives sound recording information (YES in step S74), the acquisition part 111A stores the sound recording information received by the communication part 13A in the sound information storage part 124, in step S75. The sound recording information associates at least one piece of sound information and meta information about the at least one piece of sound information with each other. The meta information includes a photographing ID, a sound recording start date and time, and a sound recording finish date and time.

Step S76 and step S77 are the same as step S36 and step S37 in FIG. 5, an thus, the descriptions therefor will be omitted.

Then, in step S78, the display control part 112A determines whether a photographing period includes a sound recording start date and time for the sound information. When it is determined that the photographing period includes no sound recording start date and time for the sound information (NO in step S78), the display control part 112A sends display data for a design drawing to the first information terminal 20 via the communication part 13A, and then causes a display 23 of the first information terminal 20 to display the design drawing, in step S79.

Step S80 is the same as step S40 in FIG. 5, and thus, the descriptions therefor will be omitted.

In contrast, when it is determined that the photographing period includes a sound recording start date and time for the sound information (YES in step S78), the display control part 112A selects, in step S81, a photographing spot with a photographing date and time that is closer to the sound recording start date and time for the sound information among a plurality of photographing spots. The display control part 112A selects a photographing spot with the same photographing date and time as the sound recording start date and time for the sound information. When there is no photographing spot with a photographing date and time that is the same as the sound recording start date and time for the sound information, the display control part 112A selects a photographing spot with a photographing date and time that is closest to the sound recording start date and time for the sound information.

Step S82 to step S86 are the same as step S42 to step S46 in FIG. 6, and thus, the descriptions therefor will be omitted.

Next, in step S87, the display control part 112A sends, to the first information terminal 20 via the communication part 13A, a display instruction to display, in a blank area within the design drawing, a second icon showing association of the sound information with a first icon having a photographing date and time that is closer to the sound recording start date and time for the sound information among a plurality of first icons, and then displays the second icon in the blank area within the design drawing.

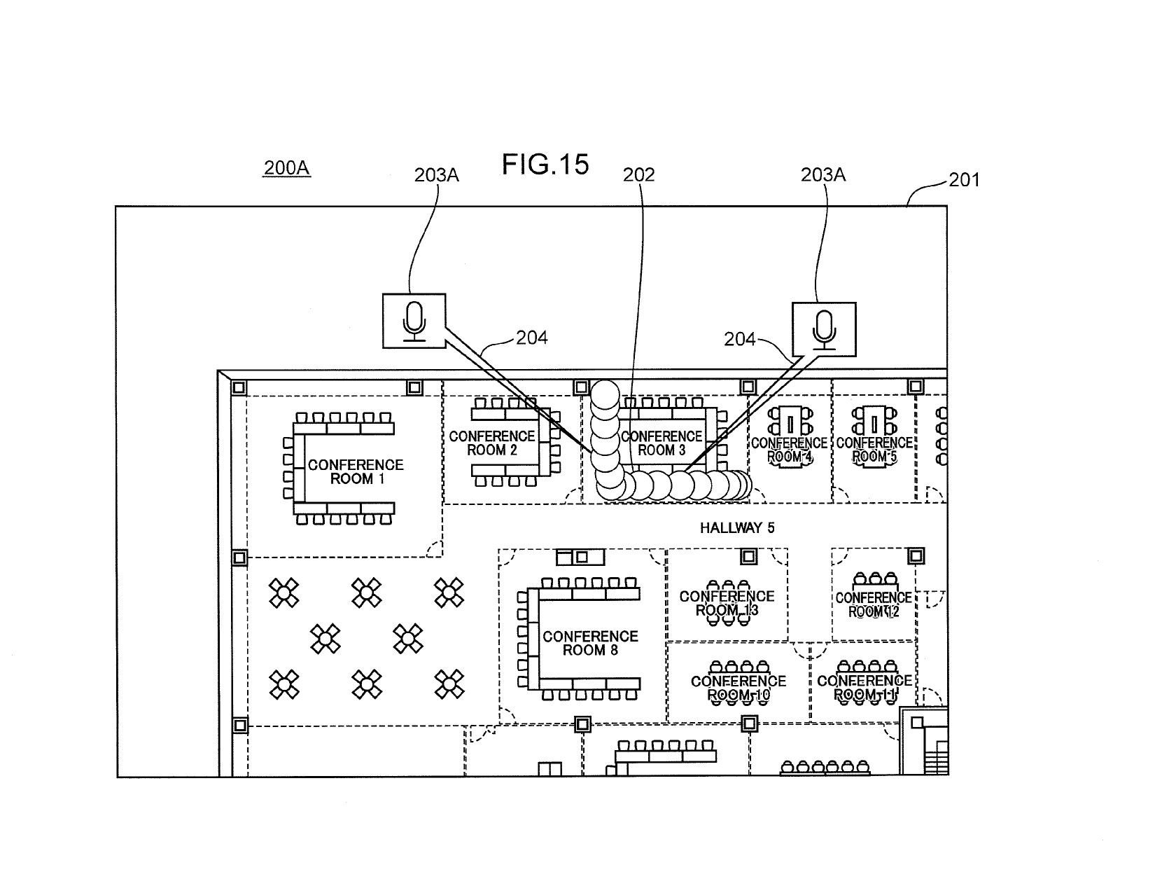

FIG. 15 illustrates an example design drawing screen image 200A displayed on the first information terminal 20 in the second embodiment.

The design drawing screen image 200A shows a design drawing 201 for a workspace. In the design drawing screen image 200A, a plurality of first icons 202 is superimposed and displayed. Further, the design drawing screen image 200A shows, in a blank area within the design drawing 201, a second icon 203A showing association of sound information with a first icon 202 having a photographing date and time that is closer to a sound recording stard date and time for the sound information among the first icons 202. For instance, the second icon 203A has a quadrangular shape and includes an image imitating a microphone.

The first icons 202 and an outline 204 in the second embodiment are respectively equivalent to the first icons 202 and the outline 204 in the first embodiment.

The display control part 112A is configured to display the second icon 203A at such a position as to avoid overlapping a character or a shape in the design drawing 201. The display control part 112A may be configured to display the second icon 203A in a blank area inside a building shown in the design drawing 201, in a blank area outside the building shown in the design drawing 201, or in an area expect for a region including the first icons 202 in the design drawing 201.

The second icon 203A is associated with the sound information recorded by the second information terminal 40A. A manipulation part 24 may receive selection of the second icon 203A by a user. When the second icon 203A is selected, the display control part 112A may read out, from the sound information storage part 124, sound information corresponding to the selected second icon 203A, and cause a speaker to output the read out sound information therefrom. It is noted here that the first information terminal 20 further includes the speaker. In this case, the communication part 13A may send to the first information terminal 20, the sound information corresponding to the second icon 203A. The speaker included in the first information terminal 20 may output the received sound information.

In a case where a plurality of pieces of sound information is associated with a photographing ID, the display control part 112A may display, in the design drawing 201, a plurality of second icons 203A respectively indicating a plurality of sound recording start spots for the pieces of sound information.

Although the display control part 112A is configured to display the second icon 203A differently from the first icons 202 in the second embodiment, the present disclosure is not particularly limited thereto. The display control part 112A may be configured to display a first icon having a photographing date and time that is closer to a sound recording start date and time for sound information differently from another first icon. In this case, the display control part 112A may differentiate a color of the first icon having the photographing date and time that is closer to the sound recording start date and time for the sound information from a color of another first icon, or may differentiate a shape of the first icon having the photographing date and time that is closer to the sound recording start date and time for the sound information from a shape of another first icon.

Conclusively, this configuration includes displaying, in the design drawing 201, the first icons 202 respectively indicating the photographing spots for the first images captured by the photographing device 30 and the second icon 203 indicating the sound recording start spot for the sound information recorded by the second information terminal 40A during capturing of the first images. The configuration thus allows the user to know the presence of a comment with a sound or voice concerning a photographing spot for a certain first image. The configuration further allows the user to save the time for sorting the sound information recorded during the capturing of the first images, and hence achieves improvement in the convenience for the user.

Third embodiment In the second embodiment, sound information recorded by the second information terminal 40A during capturing of a plurality of first images by the photographing device 30 is acquired. In contrast, in a third embodiment, sound information recorded by a photographing device 30B during capturing of a plurality of first images by the photographing device 30B is acquired.

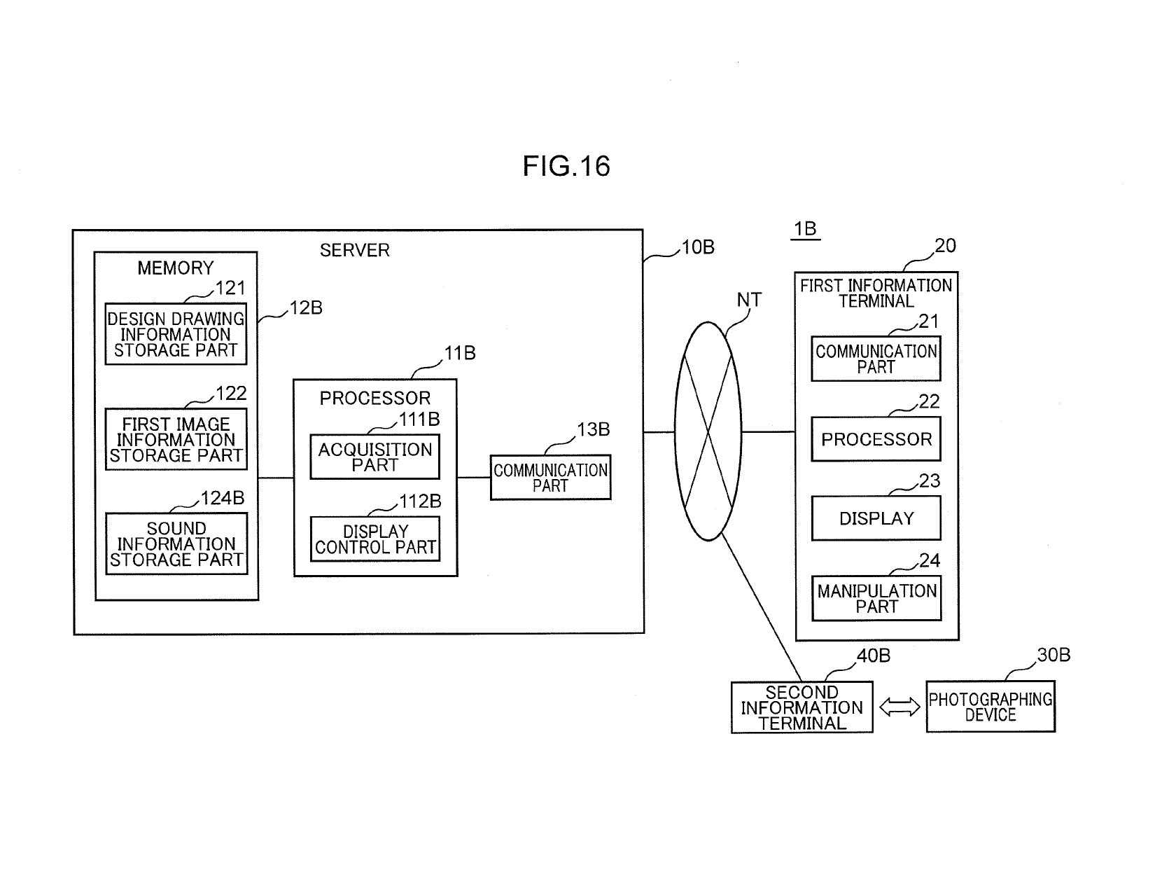

FIG. 16 is a diagram showing an overall configuration of an information processing system 1B in the third embodiment.

The information processing system 1B includes a server 10B, a first information terminal 20, the photographing device 30B, and a second information terminal 40B. In the third embodiment, elements which are the same as those in the first embodiment and the second embodiment are given the same reference signs and numerals, and thus, the descriptions therefor will be omitted. Further, in a configuration of the third embodiment, the descriptions for the operability or function which is the same as that in the first embodiment and the second embodiment will be also omitted.

The photographing device 30B is an example of a photographing device and a sound recording device.

The photographing device 30B includes, for example, an omnidirectional camera, and captures a first image at a predetermined frame rate. The photographing device 30B further includes a microphone that collects a sound or voice therearound. The photographing device 30B is configured to record sound information during capturing of a plurality of first images. The photographing device 30B is, for example, a portable photographing device carriable by a photographing person. The photographing person is, for example, a worker or a site supervisor on a construction site. The photographing device 30B may execute photographing in a state of being held in a hand of the photographing person or in a state of being attached to a body (e.g., the head) of the photographing person. The photographing device 30B may include a typical camera.

The photographing person moves on the construction site while photographing the construction site and performing sound recording with the photographing device 30B. The photographing person presses, at a photographing start spot, a photographing button of the photographing device 30B while making a photographing direction of the photographing device 30B agree with the north direction to start photographing and sound recording and presses the photographing button again to finish the photographing and the sound recording when reaching a photographing finish spot. When the photographing and the sound recording are finished, the photographing device 30B sends a series of first images having been captured and the sound information to the second information terminal 40B. The photographing device 30B is configured to record the sound information in a period from the start to the finish of the photographing for the first images.

First, the photographing device 30B displays the photographing button to instruct start or stop of photographing and receives pressing of the photographing button by the photographing person. Next, the photographing device 30B determines whether the photographing button is pressed to instruct the start of the photographing. The photographing device 30B starts to capture a first image and record sound information in response to pressing of the photographing button, and causes a memory provided inside to store the captured first image and the recorded sound information. Subsequently, the photographing device 30B determines whether the photographing button is pressed to instruct the stop of the photographing. The photographing device 30B stops storing of a subsequent first image and recording of sound information in response to pressing of the photographing button and sends a plurality of first images and the sound information stored in the memory provided inside to the second information terminal 40B.

The second information terminal 40B is configured to receive the first images and the sound information sent from the photographing device 30B. The second information terminal 40B is further configured to display a design drawing for a construction site, and receive designation by the photographing person about a position corresponding to the photographing start spot and a position corresponding to the photographing finish spot in the design drawing.

The second information terminal 40B is configured to send, to the server 10B via a network NT, first photographing information including the captured first images and the collected sound information. The first photographing information is generated at every execution of one photographing operation. The one photographing operation means a series of actions from start of photographing to finish of the photographing by a worker carrying the photographing device 30B on the construction site. A plurality of first images is captured and sound information is collected through the one photographing operation. The first photographing information includes the captured first images, meta information about each of the first images, and the collected sound information. The meta information includes a photographing ID, a photographing date and time, and a design drawing ID. The photographing ID is an identifier to identify a photographing operation. The photographing date and time represents a photographing date and time for each first image. The design drawing ID is an identifier to identify a design drawing for a predetermined space corresponding to an image.

The second information terminal 40B is configured to receive designation by the photographing person about a sound recording start date and time and a sound recording finish date and time. The sound recording start date and time is specified by pressing of a sound recording start button displayed on a display of the second information terminal 40B by the photographing person. The sound recording finish date and time is specified by pressing of a sound recording stop button displayed on the display of the second information terminal 40 by the photographing person. The server 10B uses the sound recording start date and time and the sound recording finish date and time to specify only a necessary part of the sound information recorded in a period from the start to the finish of photographing for the first image.

The photographing person moves on the construction site while photographing the construction site and performing sound recording with the photographing device 30B. At this time, the photographing person makes an utterance at a desired place on the construction site. The photographing device 30B includes a microphone configured to collect a voice of the photographing person. The second information terminal 40B is configured to receive input by the photographing person about a sound recording start date and time and a sound recording finish date and time for sound information to be stored in the server 10B among the sound information collected by the photographing device 30B. The second information terminal 40B is configured to store only the sound recording start date and time and the sound recording finish date and time without storing the sound information during capturing of the first images.

The second information terminal 40B is configured to send, to the server 10B via the network NT, sound recording date and time information including the sound recording start date and time and the sound recording finish date and time designated by the second information terminal 40B during the capturing of the first images by the photographing device 30B. The sound recording date and time information includes a sound recording start date and time, a sound recording finish date and time, and a photographing ID. The photographing ID is an identifier to identify a photographing operation. The photographing ID is the same as the photographing ID associated with the first images. Each of the sound recording start date and time and the sound recording finish date and time is acquired by, for example, a timepiece included in the second information terminal 40B.

The server 10B includes a processor 11B, a memory 12B, and a communication part 13B. The processor 11B includes, for example, a central processing unit (CPU). The processor 11B includes an acquisition part 111B and a display control part 112B. Each of the acquisition part 111B and the display control part 112B may come into effect, for example, when the processor 11B executes an information processing program, or may be established in the form of a dedicated hardware circuit, such as an ASIC. The information processing program may be recorded in a non-transitory computer-readable recording medium.

The communication part 13B includes a communication interface that connects the server 10B to the network NT. The communication part 13B is configured to receive the first photographing information sent from the second information terminal 40B. The first photographing information includes a plurality of first images and sound information. The communication part 13B is configured to receive the sound recording date and time information sent from the second information terminal 40B. In this way, the communication part 13B acquires content information recorded by the photographing device 30B, that is, acquires the sound information recorded by the photographing device 30B. The communication part 13B is configured to receive from a first information terminal 20, instruction signals respectively indicating various instructions received from a user. The communication part 13B is configured to send to the first information terminal 20, display data to display various display screen images.

The memory 12B includes a non-volatile and rewritable storage device, such as a hard disk drive or a solid-state drive. The memory 12B includes a design drawing information storage part 121, a first image information storage part 122, and a sound information storage part 124B.

The acquisition part 111B is configured to generate sound recording information on the basis of the sound information included in the first photographing information received by the communication part 13B and on the basis of the sound recording date and time information received by the communication part 13B and store the generated sound recording information in the sound information storage part 124B. The acquisition part 111B extracts, from the sound information included in the first photographing information, specific sound information in a recording period specified by a sound recording start date and time and a sound recording finish date and time included in the sound recording date and time information. The acquisition part 111B then generates sound recording information associating the extracted sound information and meta information with each other. The meta information includes a photographing ID, a sound recording start date and time, and a sound recording finish date and time.

The sound information storage part 124B stores the sound recording information including the sound information. The sound recording information associates at least one piece of sound information extracted from the sound information collected by the photographing device 30B and meta information about the extracted at least one piece of sound information with each other. The sound recording information is stored at every receipt of the sound recording information.

The acquisition part 111B is configured to acquire, from the first image information storage part 122, a plurality of photographing dates and times for a plurality of first images corresponding to the photographing ID, and acquire, from the sound information storage part 124B, a recording sound recording start date and time for sound information corresponding to the photographing ID.

The display control part 112B is configured to display, in the design drawing, information showing association of content information with a first icon having a photographing time that is closer to a recording time for the content information among a plurality of first icons. In the third embodiment, the photographing time represents a photographing date and time for each first image, the content information includes sound information recorded by the photographing device 30B during capturing of the first images by the photographing device 30B, and the recording time represents a sound recording start date and time or a sound recording finish date and time for the sound information. The information showing association of the sound information with the first icon constitutes a second icon different from the first icons. That is to say, the display control part 112B is configured to display, in the design drawing, the second icon showing association of the sound information with a first icon having a photographing date and time that is closer to a recording start date and time for the sound information among the first icons.

Here, a process by the second information terminal 40B in the third embodiment will be described.

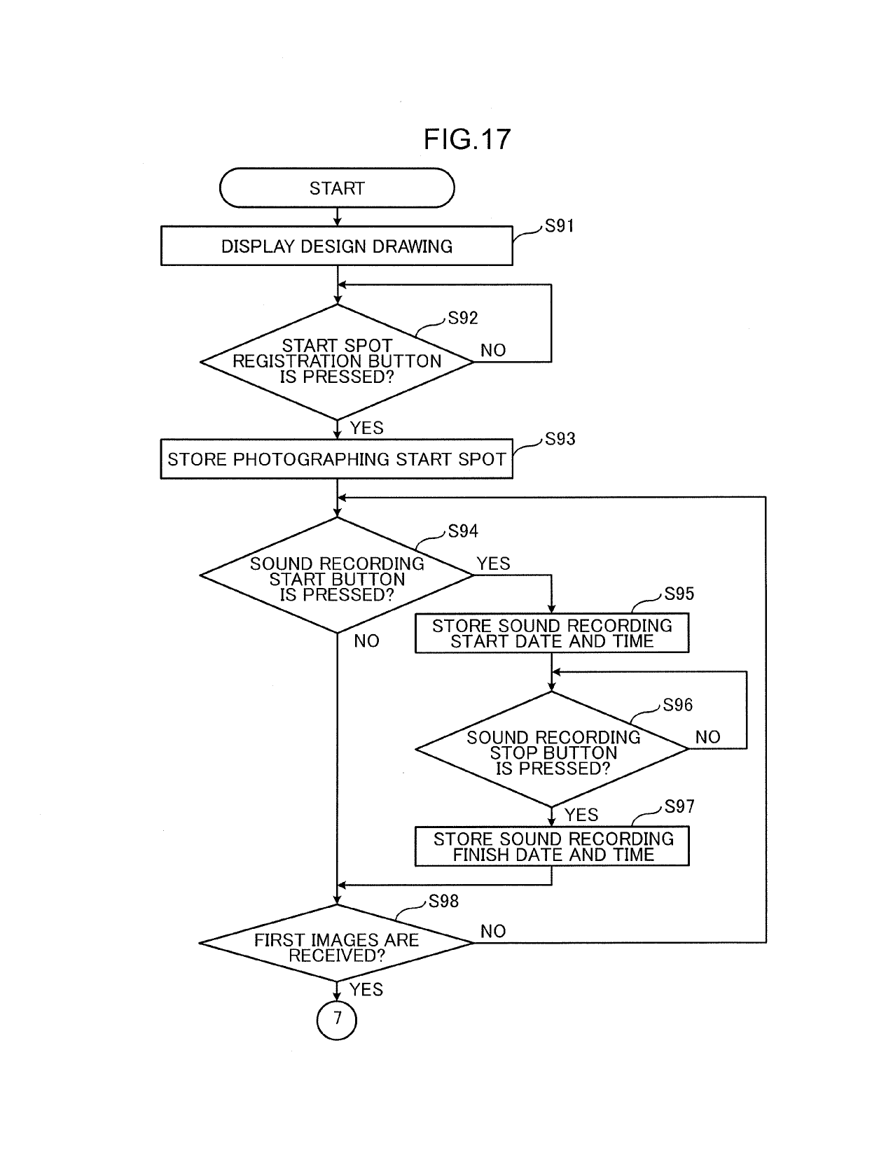

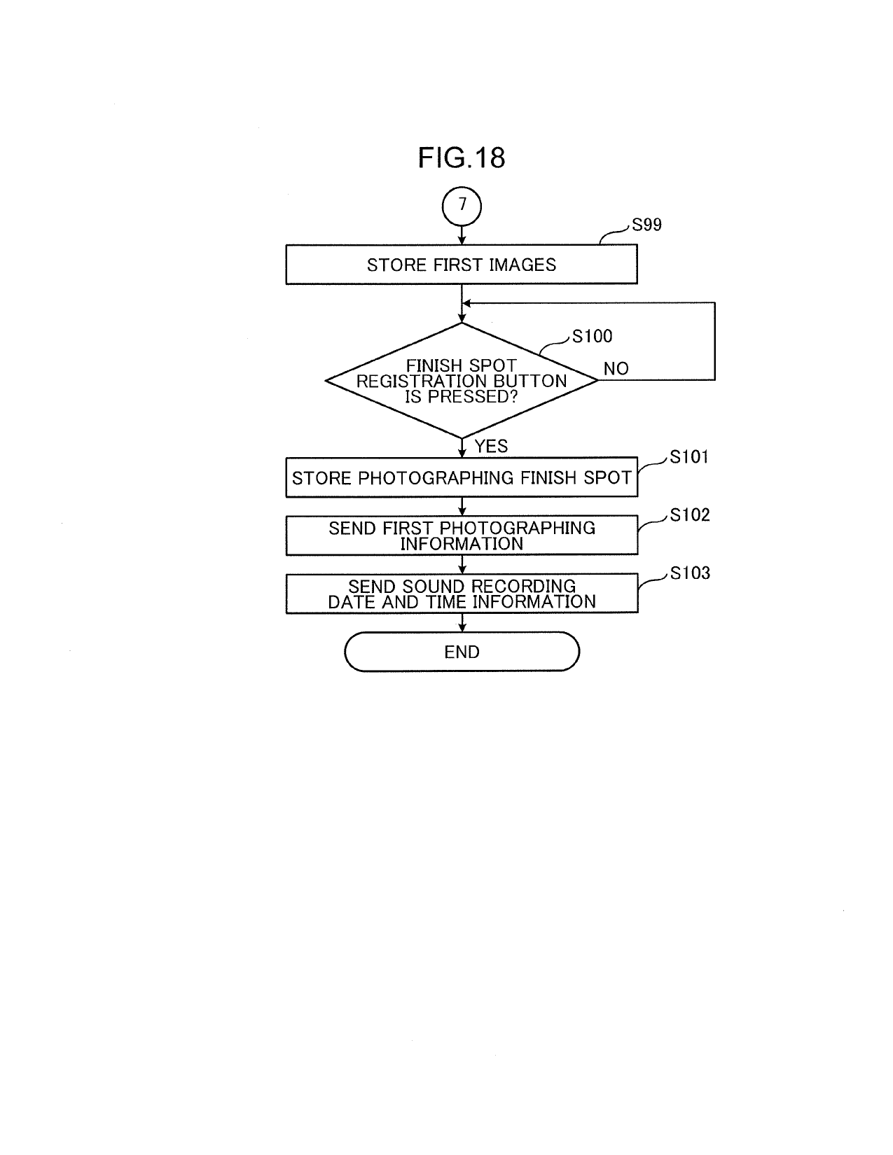

FIG. 17 is a first flowchart showing an example of the process by the second information terminal 40B in the third embodiment. FIG. 18 is a second flowchart showing an example of the process by the second information terminal 40B in the third embodiment.

Step S91 to step S93 are the same as step S11 to step S13 in FIG. 2, and thus, the descriptions therefor will be omitted.

Next, in step S94, the second information terminal 40B determines whether the sound recording start button is pressed. The second information terminal 40B displays the sound recording start button to receive a sound recording start date and time for a sound or voice after a start spot registration button is pressed.

It is noted here that a display screen image to be displayed on the second information terminal 40B when sound recording is started in the third embodiment is the same as the display screen image in the second embodiment as illustrated in FIG. 11. A photographing person presses a sound recording start button 402 when the photographing person wishes to record a sound or voice during movement while performing photographing with the photographing device 30B. For instance, the photographing person presses the sound recording start button 402 and makes an utterance at a certain place for which the photographing person wishes to leave a comment while photographing the construction site and performing sound recording. In this way, a sound recording start date and time for an utterance content of the photographing person is stored.

When it is determined that the sound recording start button is pressed (YES in step S94), the second information terminal 40B stores, in step S95, a sound recording start date and time indicating a date and time to start sound recording of sound information. The sound recording start date and time is stored in a memory included in the second information terminal 40B.

Next, in step S96, the second information terminal 40B determines whether the sound recording stop button is pressed. The second information terminal 40B displays the sound recording stop button to receive a sound recording finish date and time for the sound or voice after the sound recording start button is pressed.

It is noted here that a display screen image to be displayed on the second information terminal 40B when the sound recording is finished in the third embodiment is the same as the display screen image in the second embodiment as illustrated in FIG. 12. The photographing person presses a sound recording stop button 403 to finish the sound recording. For instance, the photographing person presses the sound recording stop button 403 when finishing the utterance. Consequently, a sound recording finish date and time for an utterance content of the photographing person is stored. A period from the sound recording start date and time to the sound recording finish date and time indicates a period for which the photographing person wishes to keep specific sound information among the sound information collected by the photographing device 30B during the photographing period. This allows the photographing person to leave a comment with a sound or voice for a desired period.

When it is determined that the sound recording stop button is pressed (YES in step S96), the second information terminal 40B stores, in step S97, a sound recording finish date and time indicating a date and time to finish the sound recording of the sound information. The sound recording finish date and time is stored in the memory included in the second information terminal 40B.

In contrast, when it is determined that the sound recording stop button is not pressed (NO in step S96), step S96 is repeated.

When the sound recording finish date and time is stored in step S97 or it is determined that the sound recording start button is not pressed (NO in step S94), the second information terminal 40B determines, in step S98, whether a plurality of first images is received from the photographing device 30B.

Step S98 to step S102 are the same as step S17 to step S21 in FIG. 2 and FIG. 3, and thus, the descriptions therefor will be omitted.

Subsequently, in step S103, the second information terminal 40B sends, to the server 10B, sound recording date and time information including at least one combination of a sound recording start date and time and a sound recording finish date and time.

In the third embodiment, the second information terminal 40B may receive selection of a combination of a sound recording start date and time and a sound recording finish date and time to be sent to the server 10B. The photographing person may designate a plurality of combinations of sound recording start dates and times and sound recording finish dates and times during movement in some cases. In such a case where a plurality of combinations of sound recording start dates and times and sound recording finish dates and times is designated, the photographing person may select a combination of a sound recording start date and time and a sound recording finish date and time to be sent to the server 10B from among the combinations of sound recording start dates and times and the sound recording finish dates and times designated during the movement. The second information terminal 40B may send, to the server 10B, sound recording date and time information including selected at least one combination of a sound recording start date and time and a sound recording finish date and time. Further, the selection of the combination of the sound recording start date and time and the sound recording finish date and time, and the sending of the sound recording date and time information may be executed after a lapse of certain time from execution of step S102. When no sound recording start date and time and no sound recording finish date and time is stored during capturing of the first images by the photographing device 30B, step S103 may not be executed.

Next, a process by the server 10B in the third embodiment will be described.

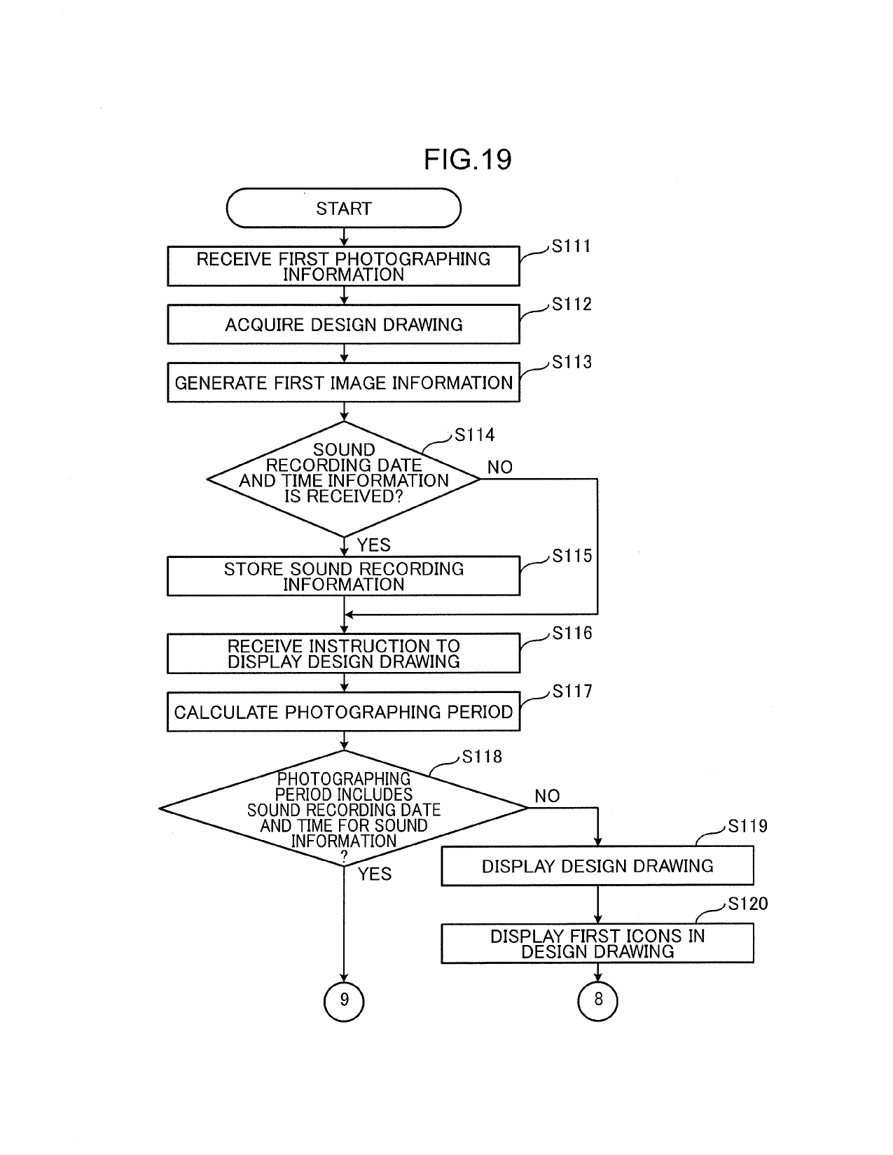

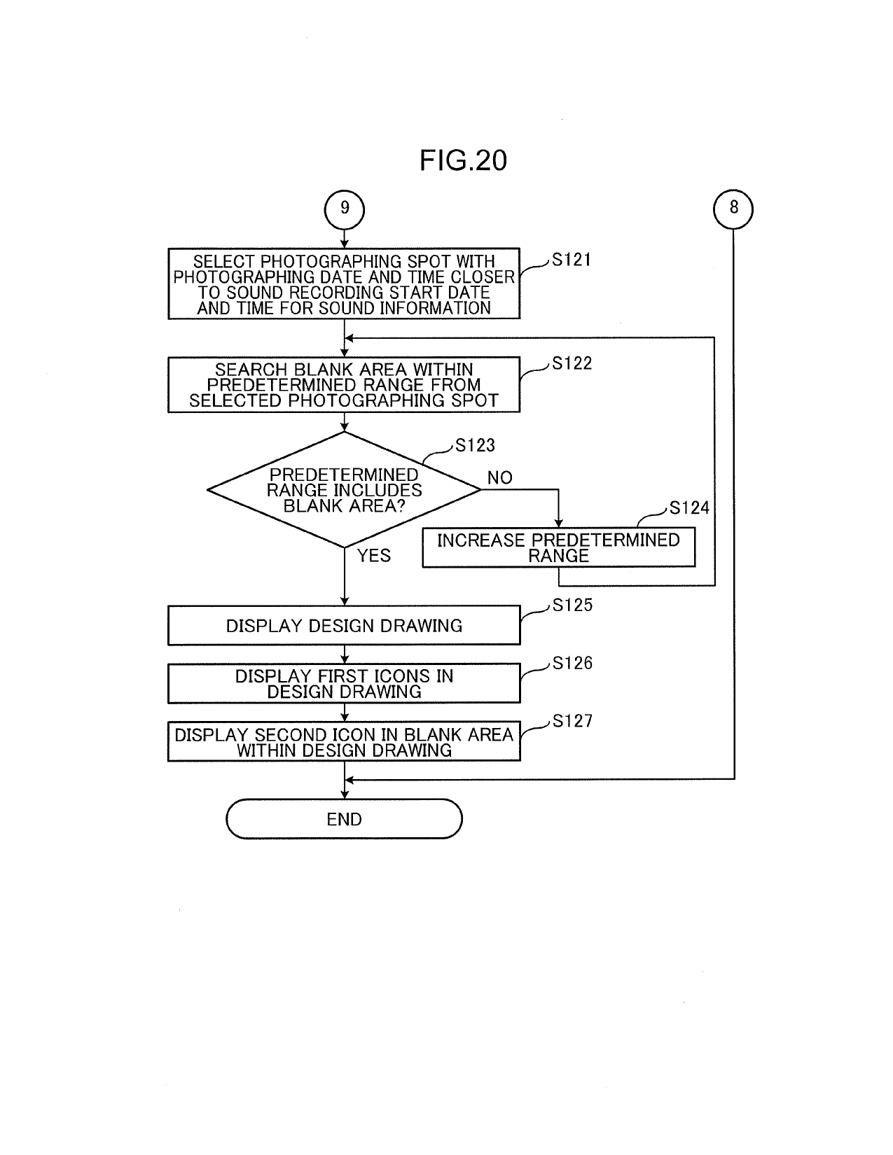

FIG. 19 is a first flowchart showing an example of the process by the server 10B in the third embodiment. FIG. 20 is a second flowchart showing an example of the process by the server 10B in the third embodiment.

Step S111 to step S113 are the same as step S31 to step S33 in FIG. 5, and thus, the descriptions therefor will be omitted.

Subsequently, in step S114, the acquisition part 111B determines whether the communication part 13B receives sound recording date and time information.

When it is determined that the communication part 13B receives no sound recording date and time information (NO in step S114), the process proceeds to step S116.

In contrast, when it is determined that the communication part 13B receives sound recording date and time information (YES in step S114), the acquisition part 111B generates sound recording information on the basis of the sound information included in first photographing information received by the communication part 13B and on the basis of the sound recording date and time information received by the communication part 13B, and stores the generated sound recording information in the sound information storage part 124B, in step S115. The sound recording information associates at least one piece of sound information and meta information about the at least one piece of sound information with each other. The meta information includes a photographing ID, a sound recording start date and time, and a sound recording finish date and time.

Step S116 to step S127 are the same as step S76 to step S87 in FIG. 13 and FIG. 14, and thus, the descriptions therefor will be omitted.

It is noted here that a design drawing screen image to be displayed on the first information terminal 20 in the third embodiment is the same as the design drawing screen image 200A in the second embodiment as illustrated in FIG. 15.

A second icon 203A in the third embodiment is associated with sound information for which sound recording is executed by the photographing device 30B and for which a sound recording start date and time and a sound recording finish date and time are designated by the second information terminal 40B. A manipulation part 24 may receive selection of the second icon 203A by the user. When the second icon 203A is selected, the display control part 112B may read out, from the sound information storage part 124B, sound information corresponding to the selected second icon 203A, and cause a speaker to output the read out sound information therefrom. In this case, the communication part 13B may send to the first information terminal 20, the sound information corresponding to the second icon 203A. The speaker included in the first information terminal 20 may output the received sound information.

In the third embodiment, the acquisition part 111B generates sound recording information associating at least one piece of sound information extracted from the sound information included in the first photographing information and meta information about the at least one piece of sound information with each other and stores the generated sound recording information in the sound information storage part 124B. However, the present disclosure is not particularly limited thereto. The acquisition part 111B may generate sound recording information associating the sound information included in the first photographing information, at least one combination of a sound recording start date and time and a sound recording finish date and time, and a photographing ID with one another, and store the generated sound recording information in the sound information storage part 124B. In this case, the second icon 203A is associated with the sound information recorded by the photographing device 30B and associated with the combination of the sound recording start date and time and the sound recording finish date and time designated by the second information terminal 40B. When the second icon 203A is selected, the display control part 112B may extract, from the sound information corresponding to the selected second icon 203A, sound information in a sound recording period specified by the sound recording start date and time and the sound recording finish time corresponding to the selected second icon 203A and may cause the speaker to output the extracted sound information therefrom.

Although content information includes sound information recorded by the second information terminal 40A or the photographing device 30B during capturing of a plurality of first images by the photographing device 30 or 30B in the second or third embodiment, the present disclosure is not particularly limited thereto. The content information may include text information converted from the sound information recorded by the second information terminal 40 or the photographing device 30B during capturing of the first images by the photographing device 30 or 30B. The text information may include a sound recording start date and time.

In this configuration, the memory 12A or 12B may include a text information storage part to store the text information. The acquisition part 111A or 111B may be configured to convert the sound information into text information by employing an already existing sound recognition technology and store the text information resulting from the conversion in the text information storage part. The display control part 112A or 112B may be configured to display, in a blank area within the design drawing, a second icon showing association of the text information with a first icon having a photographing date and time that is closer to a sound recording start date and time for the text information among a plurality of first icons. The second information terminal 40A may be configured to convert the sound information into text information and send the text information resulting from the conversion to the server 10A. The acquisition part 111A may store the received text information in the text information storage part.

Fourth embodiment In the first embodiment, a second image captured by the second information terminal 40 during capturing of a plurality of first images by the photographing device 30 is acquired. In contrast, in a fourth embodiment, text information input through a second information terminal 40C during capturing of a plurality of first images by a photographing device 30 is acquired.

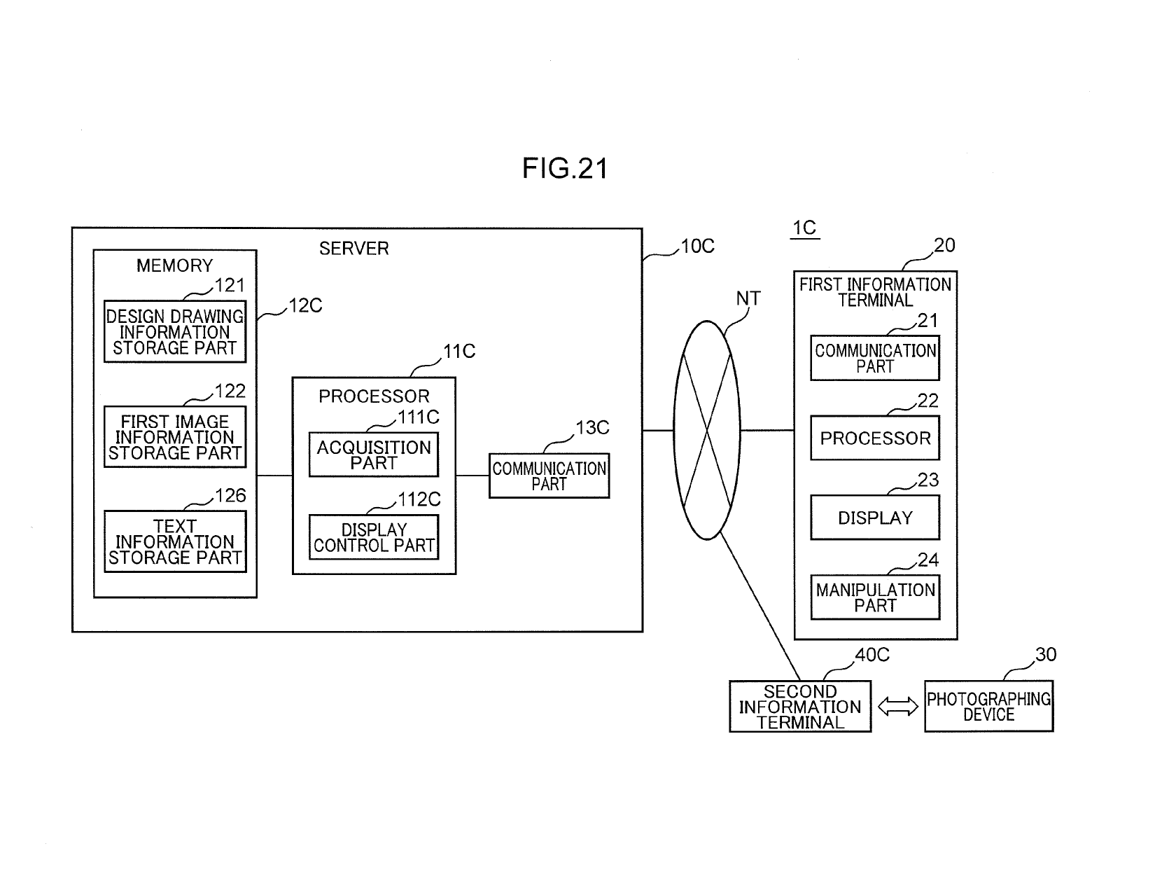

FIG. 21 is a diagram showing an overall configuration of an information processing system 1C in the fourth embodiment.

The information processing system 1C includes a server 10C, a first information terminal 20, the photographing device 30, and the second information terminal 40C. In the fourth embodiment, elements which are the same as those in the first embodiment are given the same reference signs and numerals, and thus, the descriptions therefor will be omitted. Further, in a configuration of the fourth embodiment, the descriptions for the operability or function which is the same as that in the first embodiment will be also omitted.

The second information terminal 40C includes a mobile information terminal, e.g., a smartphone or a tablet computer, and connects the photographing device 30 to a network NT. The second information terminal 40C and the photographing device 30 are communicably connected to each other via a near field communication channel, such as the Bluetooth (registered trademark). The photographing device 30 is an example of a photographing device, and the second information terminal 40C is an example of an input device.

The second information terminal 40C is configured to receive the first images sent from the photographing device 30. The second information terminal 40C is configured to send, to the server 10C via the network NT, first photographing information including the captured first images.

The second information terminal 40C further includes a manipulation part that receives input of text information by a photographing person. The manipulation part includes, for example, a keyboard, a touch screen, and a mouse. The photographing person moves on a construction site while photographing the construction site with the photographing device 30. At this time, the photographing person performs input of text information at a desired place on the construction site. The manipulation part included in the second information terminal 40C receives the input of the text information by the photographing person. A processor included in the second information terminal 40C records the text information input to the manipulation part in a memory included in the second information terminal 40C. The text information is an example of content information.

The second information terminal 40C is configured to send, to the server 10C via the network NT, at least one piece of text information input through the second information terminal 40C during capturing of the first images by the photographing device 30. The text information includes meta information. The meta information includes a photographing ID and an input date and time for the text information. The photographing ID is an identifier to identify a photographing operation. The photographing ID is the same as the photographing ID associated with the first images. The input date and time represents a date and time when the text information is input. The input date and time is acquired by, for example, a timepiece included in the second information terminal 40C.

Although the manipulation part included in the second information terminal 40C receives input of text information in the fourth embodiment, the present invention is not particularly limited thereto. Another input device different from the second information terminal 40C may receive input of text information. The second information terminal 40C may be communicably connected to the another input device, receive the text information sent from the another input device, and send the received text information to the server 10C. Alternatively, the photographing device 30 may include an input part configured to receive input of text information. In this configuration, the input part included in the photographing device 30 is an example of the input device.

The server 10C includes a processor 11C, a memory 12C, and a communication part 13C. The processor 11C includes, for example, a central processing unit (CPU). The processor 11C includes an acquisition part 111C and a display control part 112C. Each of the acquisition part 111C and the display control part 112C may come into effect, for example, when the processor 11C executes an information processing program, or may be established in the form of a dedicated hardware circuit, such as an ASIC. The information processing program may be recorded in a non-transitory computer-readable recording medium.

The communication part 13C includes a communication interface that connects the server 10C to the network NT. The communication part 13C is configured to receive first photographing information sent from the second information terminal 40C. The communication part 13C is configured to receive the text information sent from the second information terminal 40C. In this way, the communication part 13C acquires content information recorded by the second information terminal 40C, that is, acquires the text information input through the second information terminal 40C during capturing of a plurality of images by the photographing device 30. The communication part 13C is configured to receive from the first information terminal 20, instruction signals respectively indicating various instructions received from a user. The communication part 13C is configured to send to the first information terminal 20, display data to display various display screen images.

The memory 12C includes a non-volatile and rewritable storage device, such as a hard disk drive or a solid state drive. The memory 12C includes a design drawing information storage part 121, a first image information storage part 122, and a text information storage part 126.

The text information storage part 126 stores the text information input through the second information terminal 40C. The text information is associated with meta information including a photographing ID and an input date and time for the text information. The text information is stored at every receipt of the text information.

The acquisition part 111C is configured to acquire, from the first image information storage part 122, a plurality of photographing dates and times for a plurality of first images corresponding to the photographing ID, and acquire, from the text information storage part 126, an input date and time for text information corresponding to the photographing ID.

The display control part 112C is configured to display, in a design drawing, information showing association of content information with a first icon having a photographing time that is closer to a recording time for the content information among a plurality of first icons. In the fourth embodiment, the photographing time represents a photographing date and time for each first image, the content information includes text information input through the second information terminal 40C during capturing of the first images by the photographing device 30, and the recording time represents an input date and time when the text information is input. The information showing association of the text information with the first icon constitutes a second icon different from the first icons. That is to say, the display control part 112C is configured to display, in the design drawing, the second icon showing association of the text information with a first icon having a photographing date and time that is closer to an input date and time for the text information among the first icons.

Here, a process by the second information terminal 40C in the fourth embodiment will be described.

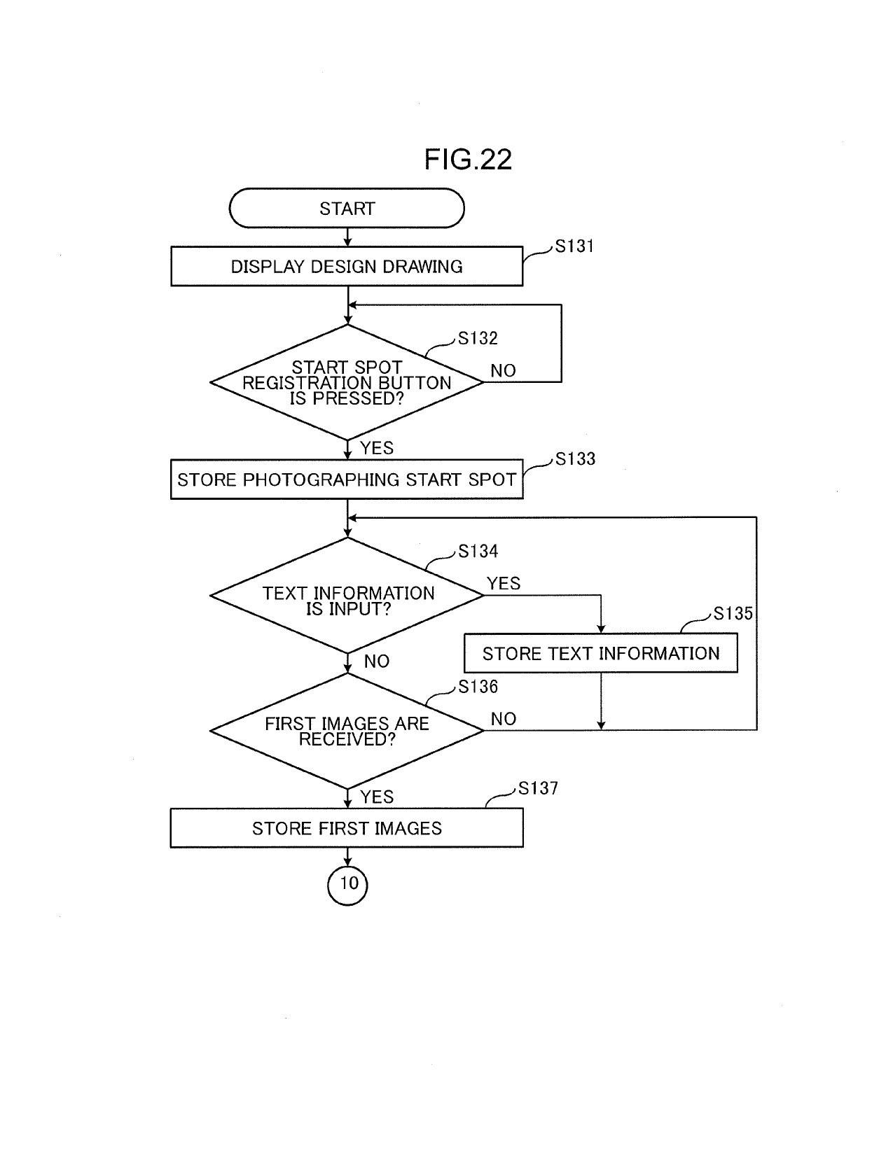

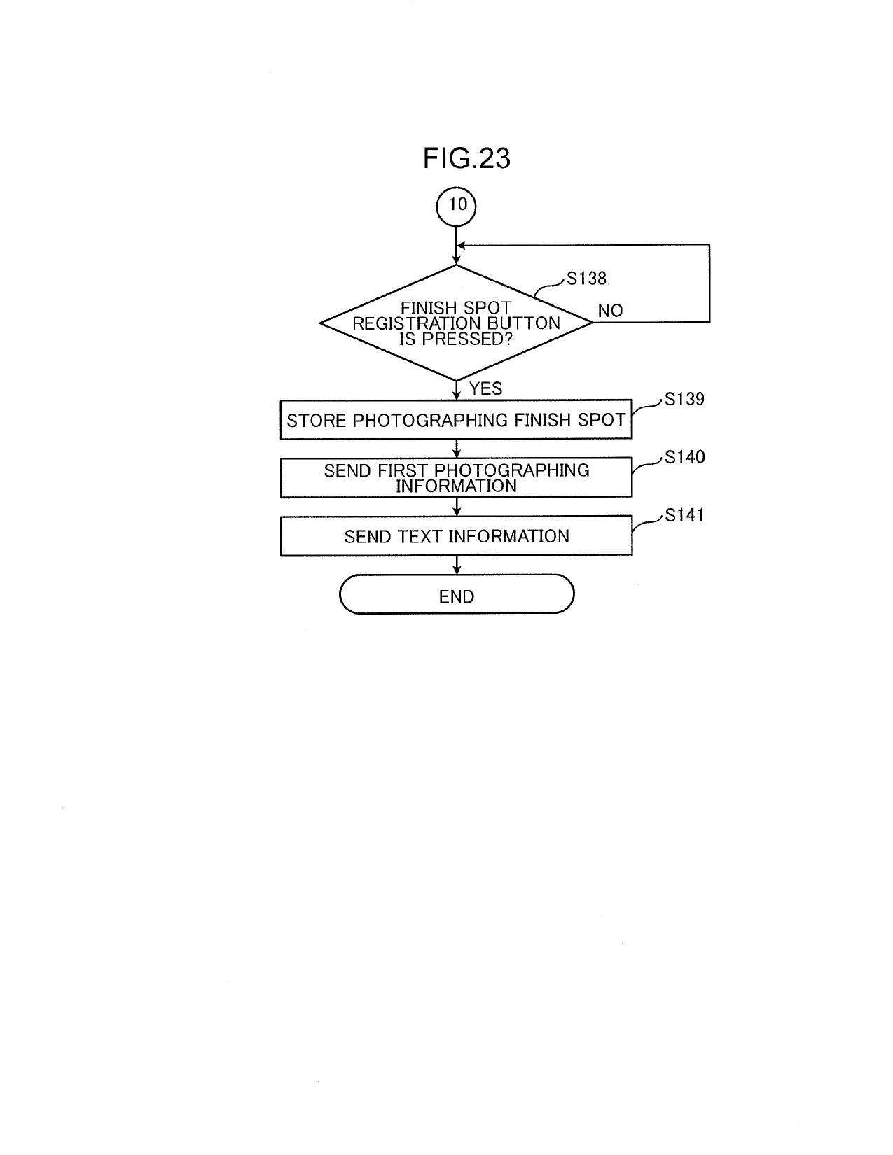

FIG. 22 is a first flowchart showing an example of the process by the second information terminal 40C in the fourth embodiment. FIG. 23 is a second flowchart showing an example of the process by the second information terminal 40C in the fourth embodiment.

Step S131 to step S133 are the same as step S11 to step S13 in FIG. 2, and thus, the descriptions therefor will be omitted.

Next, in step S134, the second information terminal 40C determines whether text information is input. After a start spot registration button is pressed, the second information terminal 40C displays a software keyboard and an input completion button to receive input of the text information. The software keyboard and the input completion button are displayed in a display screen image of the second information terminal 40C. A photographing person inputs text information by using the software keyboard when the photographing person wishes to record the text information during movement while performing photographing with the photographing device 30. For instance, the photographing person presses the input completion button when the input of the text information is finished. This allows the photographing person to leave a comment with a text concerning a photographing spot for a certain first image.

When it is determined that the text information is input (YES in step S134), the second information terminal 4C stores the text information in step S135. The text information is stored in the memory included in the second information terminal 40C. The text information includes an input date and time. The input date and time for the text information represents a date and time when the input of the text information is started, a date and time when the input of the text information is finished, a date and time when the input completion button is pressed, or a date and time when the text information is stored in the memory.

In contrast, when it is determined that no text information is input (NO in step S134), the second information terminal 40C determines, in step S136, whether a plurality of first images is received from the photographing device 30. When it is determined that a plurality of first images is not received from the photographing device 30 (NO in step S136), the process returns to step S134.

In contrast, when it is determined that a plurality of first images is received from the photographing device 30 (YES in step S136), the process proceeds to step S137.

Step S137 to step S140 are the same as step S18 to step S21 in FIG. 2 and FIG. 3, and thus, the descriptions therefor will be omitted.

Subsequently, in step S141, the second information terminal 40C sends at least one piece of text information to the server 10C.

The second information terminal 40C may receive selection of text information to be sent to the server 10C in the fourth embodiment. The photographing person may perform recording of a plurality of pieces of text information during movement in some cases. In such a case where a plurality of pieces of text information is recorded, the photographing person may select text information to be sent to the server 10C from among the pieces of text information having been recorded during the movement. The second information terminal 40C may send, to the server 10C, selected at least one piece of text information. Further, the selection of the text information and the sending of the text information may be executed after a lapse of certain time from execution of step S140. When no text information is recorded during the capturing of the first images by the photographing device 30, step S141 may not be executed.

Next, a process by the server 10C in the fourth embodiment will be described.

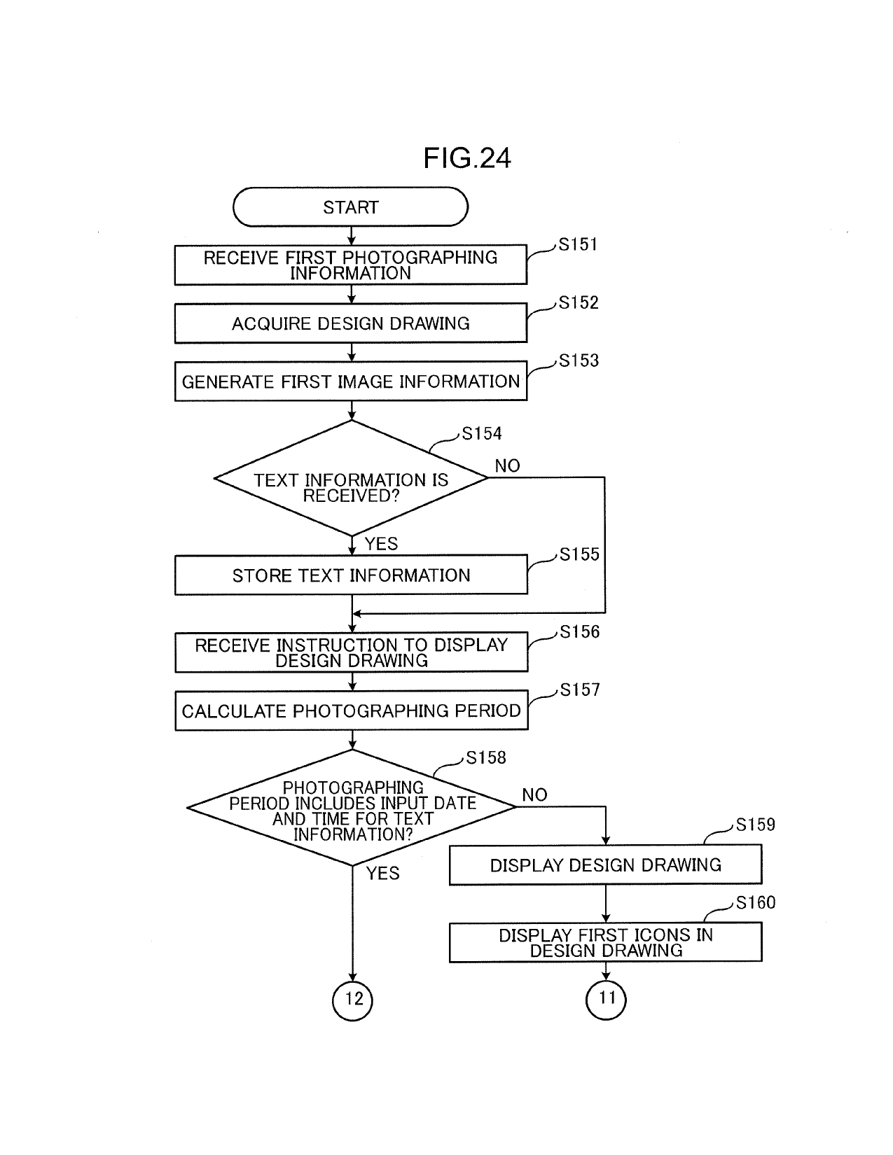

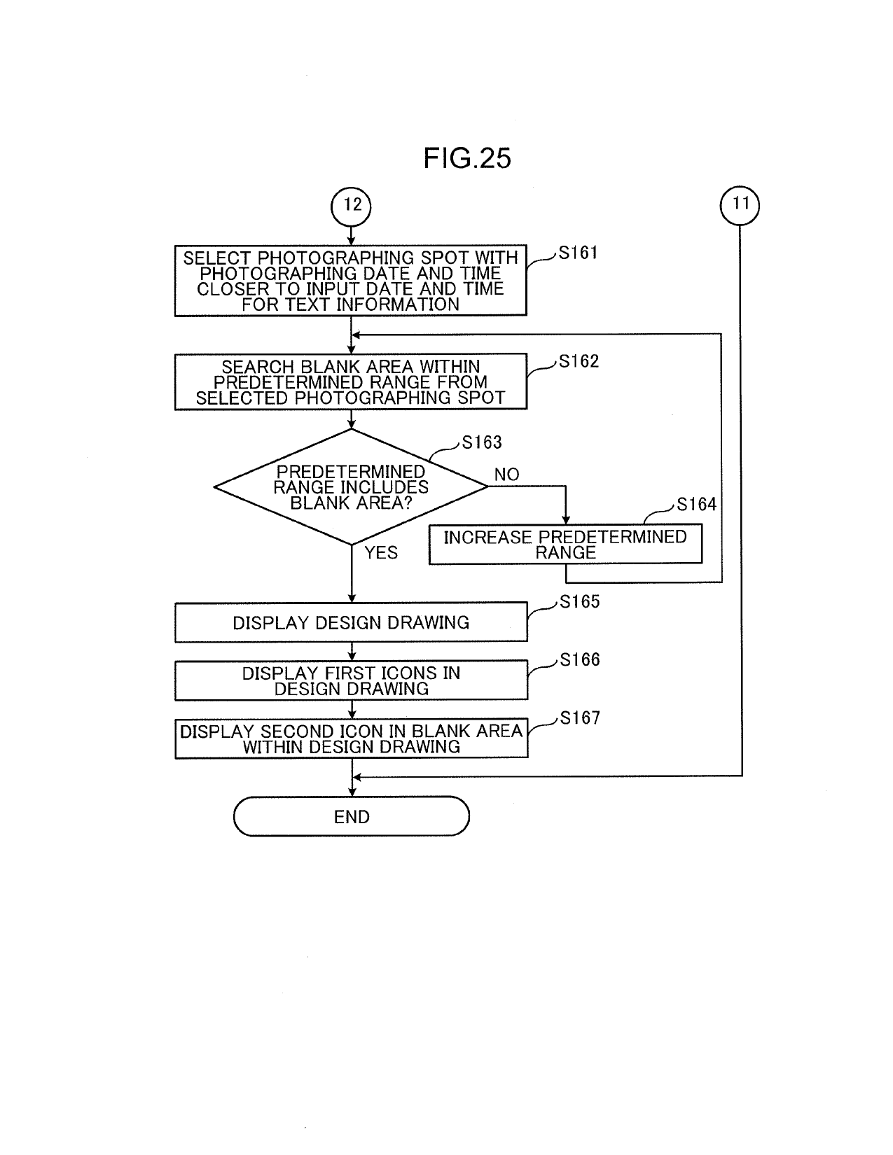

FIG. 24 is a first flowchart showing an example the process by the server 10C in the fourth embodiment. FIG. 25 is a second flowchart showing an example the process by the server 10C in the fourth embodiment.

Step S151 to step S153 are the same as step S31 to step S33 in FIG. 5, and thus, the descriptions therefor will be omitted.

Subsequently, in step S154, the acquisition part 111C determines whether the communication part 13C receives text information.

When it is determined that the communication part 13C receives no text information (NO in step S154), the process proceeds to step S156.

In contrast, when it is determined that the communication part 13C receives text information (YES in step S154), the acquisition part 111C stores the text information received by the communication part 13C in the text information storage part 126, in step S155. The text information is associated with meta information. The meta information includes a photographing ID and an input date and time for the text information.

Step S156 and step S157 are the same as step S36 and step S37 in FIG. 5, and thus, the descriptions therefor will be omitted.

Subsequently, in step S158, the display control part 112C determines whether a photographing period includes an input date and time for the text information. When it is determined that the photographing period includes no input date and time for the text information (NO in step S158), the display control part 112C sends display data for a design drawing to the first information terminal 20 via the communication part 13C, and then causes a display 23 of the first information terminal 20 to display the design drawing, in step S159.

Step S160 is the same as step S40 in FIG. 5, and thus, the descriptions therefor will be omitted.

In contrast, when it is determined that the photographing period includes an input date and time for the text information (YES in step S158), the display control part 112C selects, in step S161, a photographing spot with a photographing date and time that is closer to the input date and time for the text information among a plurality of photographing spots. The display control part 112C selects a photographing spot with the same photographing date and time as the input date and time for the text information. When there is no photographing spot with a photographing date and time that is the same as the input date and time for the text information, the display control part 112C selects a photographing spot with a photographing date and time that is closest to the input date and time for the text information.

Step S162 to step S166 are the same as step S42 to step S46 in FIG. 6, and thus, the descriptions therefor will be omitted.

Next, in step S167, the display control part 112C sends, to the first information terminal 20C via the communication part 13C, a display instruction to display, in a blank area within the design drawing, a second icon showing association of the text information with a first icon having a photographing date and time that is closer to an input date and time for the text information among a plurality of first icons, and then displays the second icon in the blank area within the design drawing.

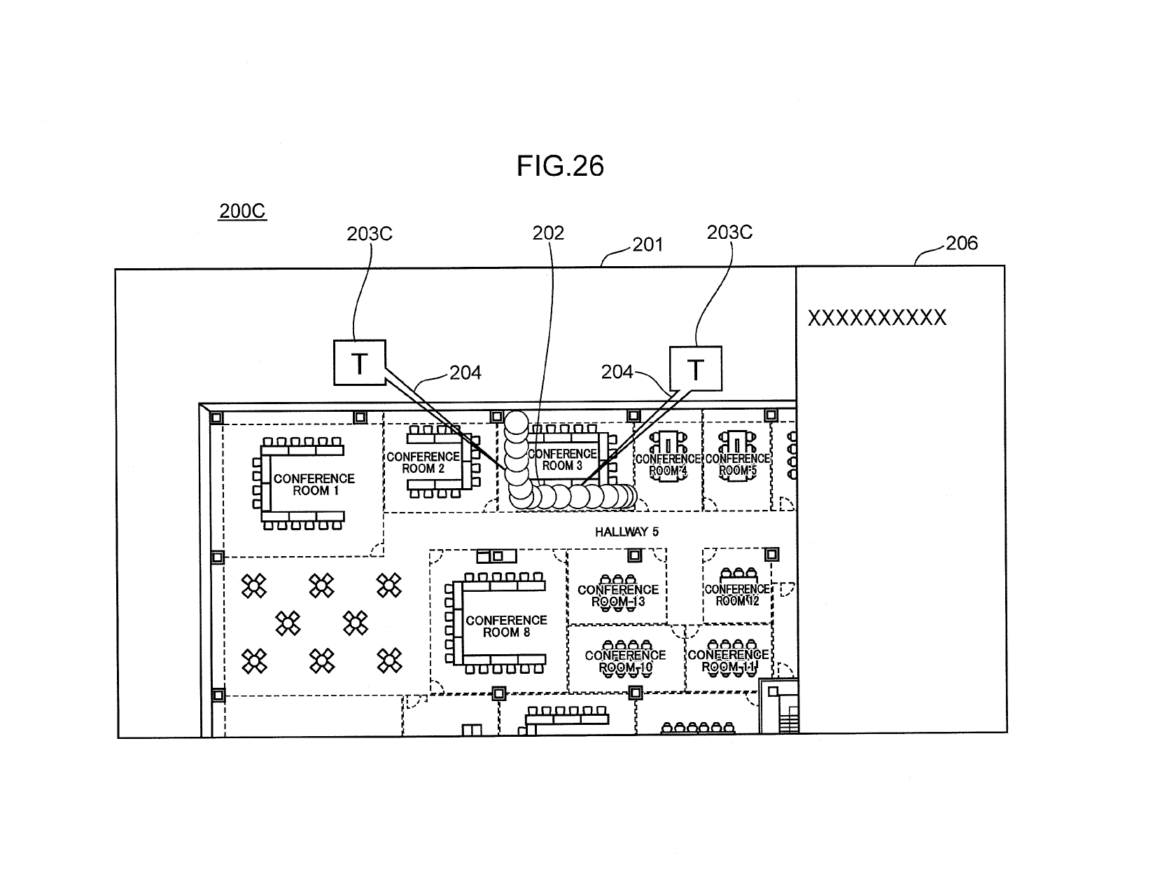

FIG. 26 illustrates an example design drawing screen image 200C displayed on the first information terminal 20 in the fourth embodiment.

The design drawing screen image 200C shows a design drawing 201 for a workspace and a text display field 206. In the design drawing screen image 200C, a plurality of first icons 202 is superimposed and displayed. Further, the design drawing screen image 200C shows, in a blank area within the design drawing 201, a second icon 203C showing association of text information with a first icon 202 having a photographing date and time that is closer to an input date and time for the text information among the first icons 202. For instance, the second icon 203C has a quadrangular shape and includes an image imitating a text. The second icon 203C is expressed with, for example, the alphabet “T”.

The first icons 202 and an outline 204 in the fourth embodiment are respectively equivalent to the first icons 202 and the outline 204 in the first embodiment.

The display control part 112C is configured to display the second icon 203C at such a position as to avoid overlapping a character or a shape in the design drawing 201. The display control part 112C may be configured to display the second icon 203C in a blank area inside a building shown in the design drawing 201, in a blank area outside the building shown in the design drawing 201, or in an area expect for a region including the first icons 202 in the design drawing 201.

The second icon 203C is associated with the text information input through the second information terminal 40C. The manipulation part 24 may receive selection of the second icon 203C by a user. When the second icon 203C is selected, the display control part 112C may read out, from the text information storage part 126, text information corresponding to the selected second icon 203C, and display the read out text information in the text display field 206. The text display field 206 shows text information associated with the second icon 203C.

In a case where a plurality of pieces of text information is associated with a photographing ID, the display control part 112C may display, in the design drawing 201, a plurality of second icons 203C respectively indicating a plurality of input spots for the pieces of text information.

Although the display control part 112C is configured to display the second icon 203C differently from the first icons 202 in the fourth embodiment, the present disclosure is not particularly limited thereto. The display control part 112C may be configured to display a first icon having a photographing date and time that is closer to an input date and time for text information differently from another first icon. In this case, the display control part 112C may differentiate a color of the first icon having the photographing date and time that is closer to the input date and time for the text information from a color of another first icon, or may differentiate a shape of the first icon having the photographing date and time that is closer to the input date and time for the text information from a shape of another first icon.

Conclusively, this configuration includes displaying, in the design drawing 201, the first icons 202 respectively indicating photographing spots for the first images captured by the photographing device 30 and the second icon 203C indicating an input spot for the text information input through the second information terminal 40C during capturing of the first images. The configuration thus allows the user to know the presence of a comment with a text concerning a photographing spot for a certain first image. The configuration further allows the user to save the time for sorting the text information input during the capturing of the first images, and hence achieves improvement in the convenience for the user.

Fifth embodiment In the second embodiment, sound information recorded by the second information terminal 40A during capturing of a plurality of first images by the photographing device 30 is acquired. In contrast, in a fifth embodiment, it is determined whether acquired sound information includes utterances of a plurality of persons, the sound information is converted into text information, and the text information available to identify each of the persons is further displayed.

An information processing system in the fifth embodiment has a configuration equivalent to the configuration of the information processing system 1A in the second embodiment shown in FIG. 8. In this respect, the fifth embodiment will be described with reference to the information processing system 1A in the second embodiment as shown in FIG. 8.

A display control part 112A is configured to analyze sound information and determine whether the sound information includes utterances of a plurality of persons. Besides, the display control part 112A is configured to convert the sound information into text information by employing an already existing sound recognition technology. The display control part 112A is further configured to display the text information available to identify each of the persons.

Next, a process by a server 10A in the fifth embodiment will be described.

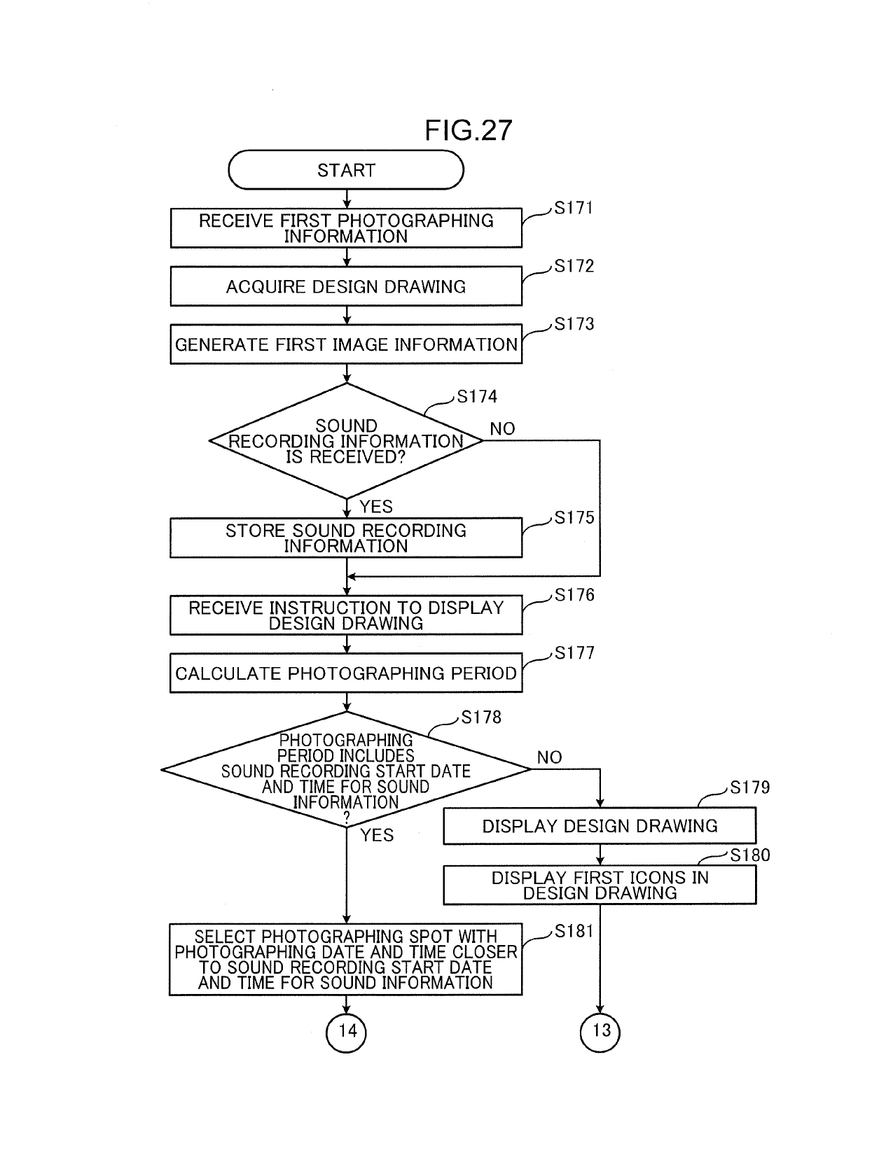

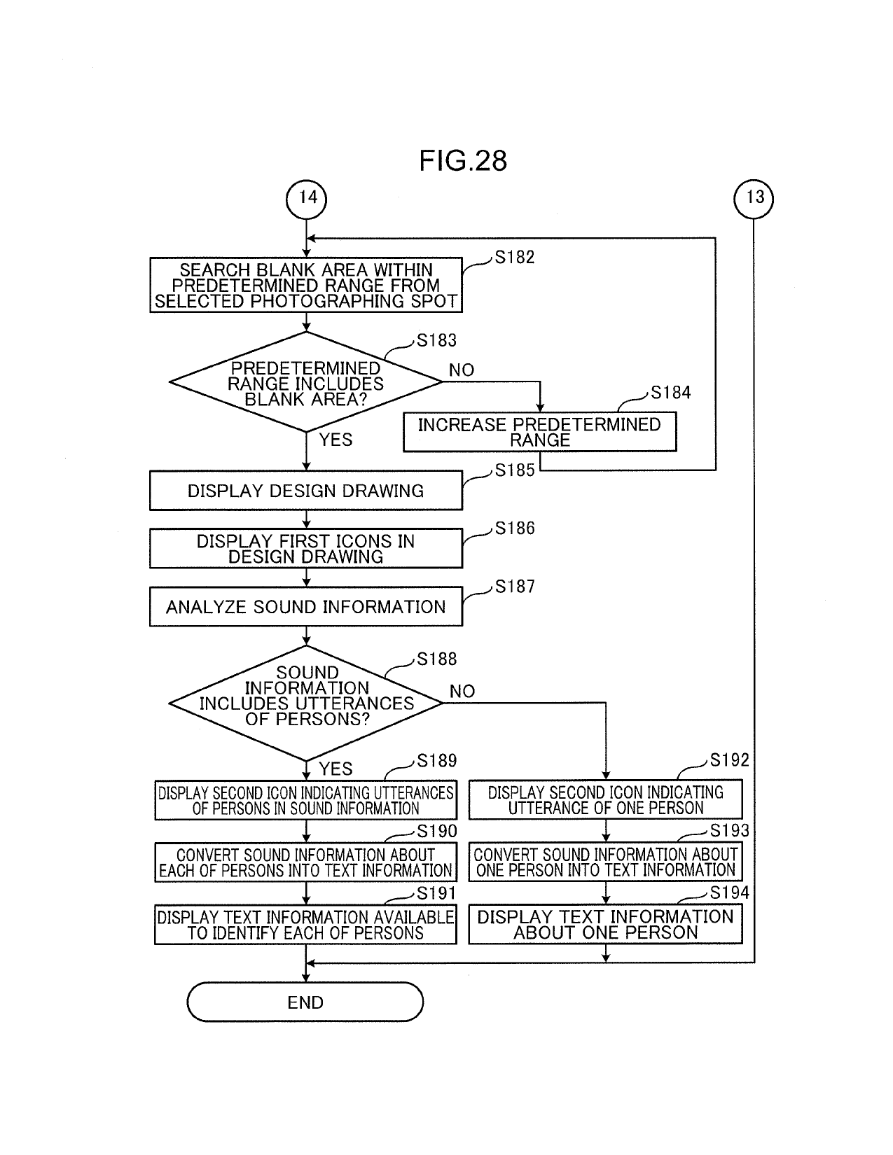

FIG. 27 is a first flowchart showing an example of the process by the server 10A in the fifth embodiment. FIG. 28 is a second flowchart showing an example of the process by the server 10A in the fifth embodiment.

Step S171 to step S186 are the same as step S71 to step S86 in FIG. 13 and FIG. 14, and thus, the descriptions therefor will be omitted.

Subsequently, in step S187, the display control part 112A analyzes sound information. The display control part 112A executes utterer identification with respect to the sound information by employing a sound recognition technology. The display control part 112A inputs the sound information into a trained machine learning model, and acquires sound information sorted per utterer from the machine learning model. The machine learning model outputs sound information sorted per utterer in response to the input of the sound information.

Then, in step S188, the display control part 112A determines whether the sound information includes utterances of a plurality of persons. When it is determined that the sound information includes utterances of a plurality of persons (YES in step S188), the display control part 112A sends, to a first information terminal 20 via a communication part 13A, a display instruction to display, in a blank area within a design drawing, a second icon showing association of the sound information with a first icon having a photographing date and time that is closer to a sound recording start date and time for the sound information among a plurality of first icons, and further indicating the utterances of the persons, and then displays the second icon indicating the utterances of the persons in the blank area within the design drawing, in step S189.

Next, in step S190, the display control part 112A converts the sound information about each of the persons into text information.

Then, in step S191, the display control part 112A sends, to the first information terminal 20 via the communication part 13A, a display instruction to display the text information available to identify each of the persons, and causes a display 23 to display the text information available to identify each of the persons.

In contrast, when it is determined that the sound information does not include utterances of a plurality of persons (NO in step S188), the display control part 112A sends, to the first information terminal 20 via the communication part 13A, a display instruction to display, in a blank area within the design drawing, a second icon showing association of the sound information with the first icon having the photographing date and time that is closer to the sound recording start date and time for the sound information among the first icons, and further indicating an utterance of one person, and then displays the second icon indicating the utterance of the one person in the blank area within the design drawing, in step S192.

Subsequently, in step S193, the display control part 112A converts the sound information about the one person into text information.

Then, in step S194, the display control part 112A sends, to the first information terminal 20 via the communication part 13A, a display instruction to display the text information about the one person, and then causes the display 23 to display the text information about the one person.

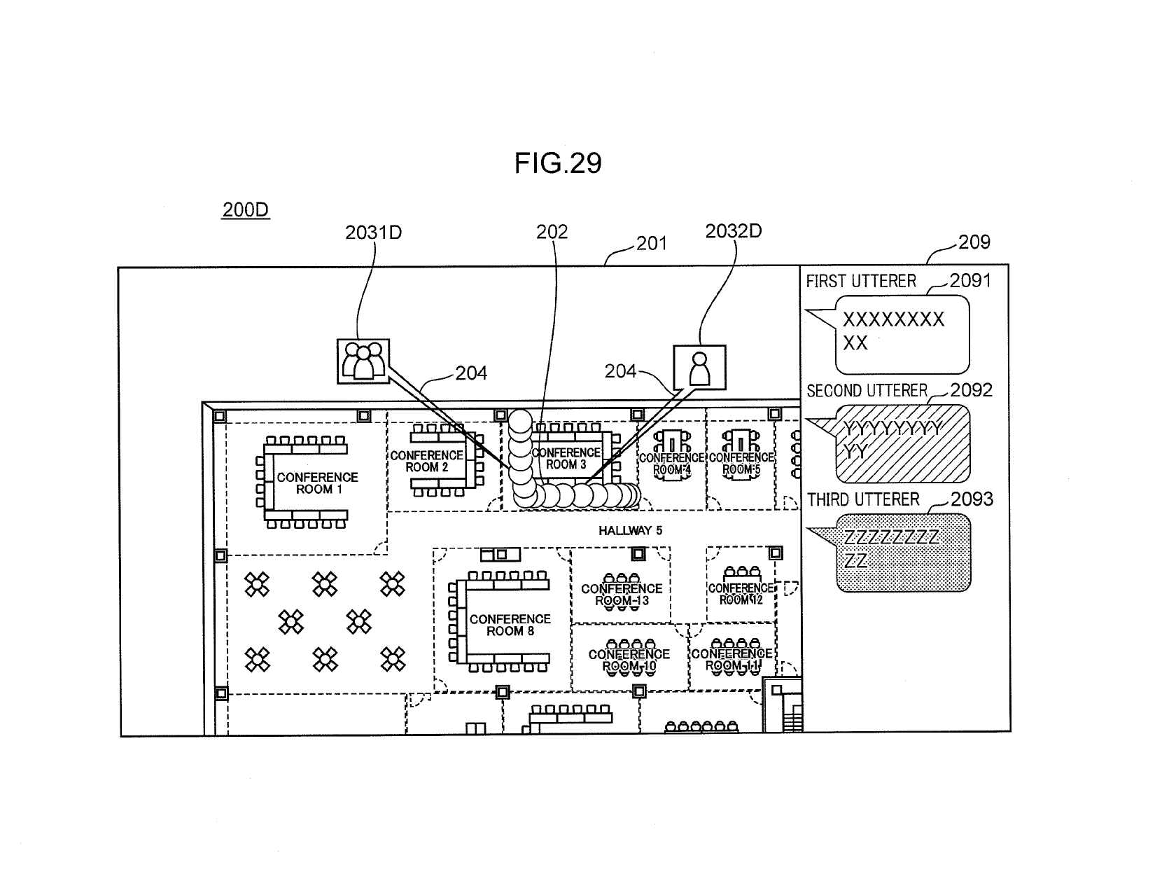

FIG. 29 illustrates an example design drawing screen image 200D displayed on the first information terminal 20 in the fifth embodiment.

The design drawing screen image 200D shows a design drawing 201 for a workspace and a text display field 209. In the design drawing screen image 200D, a plurality of first icons 202 is superimposed and displayed. Further, the design drawing screen image 200D shows, in a blank area within the design drawing 201, a second icon 2031D, 2032D showing association of sound information with a first icon 202 having a photographing date and time that is closer to a sound recording start date and time for the sound information among the first icons 202. For instance, the second icon 2031D has a quadrangular shape and includes an image imitating a plurality of persons. For instance, the second icon 2032D has a quadrangular shape and includes an image imitating one person.

The first icons 202 and an outline 204 in the fifth embodiment are respectively equivalent to the first icons 202 and the outline 204 in the first embodiment.

The display control part 112A is configured to display the second icon 2031D, 2032D at such a position as to avoid overlapping a character or a shape in the design drawing 201. The display control part 112A may be configured to display the second icon 2031D, 2032D in a blank area inside a building shown in the design drawing 201, in a blank area outside the building shown in the design drawing 201, or in an area expect for a region including the first icons 202 in the design drawing 201.

The second icon 2031D is associated with sound information recorded by the second information terminal 40A and including utterances of a plurality of persons. The second icon2032D is associated with sound information recorded by the second information terminal 40A and including an utterance of one person. A manipulation part 24 may receive selection of the second icon 2031D or 2032D by a user. When the second icon 2031D or 2032D is selected, the display control part 112A may read out, from a sound information storage part 124, sound information corresponding to the selected second icon 2031D or 2032D, and convert the read out sound information into text information.

The display control part 112A displays the text information resulting from the conversion in the text display field 209. The text display field 209 shows the text information converted from the sound information associated with the second icon 2031D or 2032D.

As illustrated in FIG. 29, when the second icon 2031D is selected, the display control part 112A displays the text information available to identify each of the persons in the text display field 209. In FIG. 29, a display region 2091 for text information about a first utterer, a display region 2092 for text information about a second utterer, and a display region 2093 for text information about a third utterer are displayed in different colors from one another.

In a case where a plurality of pieces of sound information is associated with a photographing ID, the display control part 112A may display, in the design drawing 201, a plurality of second icons 2031D, 2032D respectively indicating a plurality of sound recording start spots for the pieces of sound information.

Although the display control part 112A is configured to display the second icon 2031D, 2032D different from the first icons 202 in the fifth embodiment, the present disclosure is not particularly limited thereto. The display control part 112A may be configured to display a first icon having a photographing date and time that is closer to a sound recording start date and time for sound information differently from another first icon. In this case, the display control part 112A may differentiate a color of the first icon having the photographing date and time that is closer to the sound recording start date and time for the sound information from a color of another first icon, or may differentiate a shape of the first icon having the photographing date and time that is closer to the sound recording start date and time for the sound information from a shape of another first icon.

Although sound information recorded by a second information terminal 40A during capturing of a plurality of first images by a photographing device 30 is acquired in the fifth embodiment in the same manner as in the second embodiment, the present disclosure is not particularly limited thereto. In the fifth embodiment, sound information recorded by a photographing device 30B during capturing of a plurality of first images by a photographing device 30B may be acquired in the same manner as in the third embodiment.

In the fifth embodiment, when the second icon 2031D, 2032D is selected, the display control part 112A converts sound information corresponding to the second icon 2031D, 2032D into text information, and displays the text information resulting from the conversion. However, the present disclosure is not particularly limited thereto. When the second icon 2031D, 2032D is selected, the display control part 112A may cause a speaker to output the sound information without converting the sound information into text information.

A plurality of embodiments among the first embodiment to the fifth embodiment may be combined.

The technology according to the present disclosure allows a user to be notified of

the presence of content information having been recorded, in addition to an image captured at a photographing spot, and achieves a reduction in the number of processing steps for access to the content information, and hence is useful as a technology to display an image.

1. An information processing method to be executed by a computer, comprising:
displaying a bird’s-eye view on a display of an information terminal;
displaying, in the bird’s-eye view, a plurality of first icons respectively indicating a plurality of photographing spots in connection with photographing times;
acquiring content information having been recorded; and
displaying, in the bird’s-eye view, information showing association of the content information with a first icon having a photographing time that is closer to a recording time for the content information among the first icons.

2. The information processing method according to claim 1, wherein
the information constitutes a second icon different from the first icons.

3. The information processing method according to claim 1, wherein
the information constitutes the first icon to be displayed differently from another first icon.

4. The information processing method according to claim 1, wherein
the first icons are respectively associated with a plurality of first images captured by a first photographing device at the photographing spots, and
the content information includes a second image captured by a second photographing device during capturing of the first images by the first photographing device.

5. The information processing method according to claim 1, wherein
the first icons are respectively associated with a plurality of images captured by a photographing device at the photographing spots, and
the content information includes sound information recorded by a sound recording device during capturing of the images by the photographing device.

6. The information processing method according to claim 1, wherein
the first icons are respectively associated with a plurality of images captured by a photographing device at the photographing spots, and
the content information includes text information input through an input device during capturing of the images by the photographing device.

7. The information processing method according to claim 1, wherein
the first icons are respectively associated with a plurality of images captured by a photographing device at the photographing spots, and
the content information includes text information converted from sound information recorded by a sound recording device during capturing of the images by the photographing device.

8. The information processing method according to claim 2, wherein
the displaying of the information includes associating the second icon and the first icon with each other by an outline defining a predetermined shape.

9. The information processing method according to claim 8, wherein
each of the first icons is associated with a photographing direction in which a photographing device has captured an image at each of the photographing spots, and
a certain point on a boundary of the first icon is specified by the photographing direction associated with the first icon, and is connected to the outline.

10. The information processing method according to claim 2, wherein
the displaying of the information includes displaying the second icon at such a position as to avoid overlapping a character or a shape in the bird’s-eye view.

11. The information processing method according to claim 10, wherein
the bird’s-eye view includes a design drawing for a building, and
the displaying of the information includes displaying the second icon in a blank inside the building shown in the design drawing, in a blank outside the building shown in the design drawing, or in an area except for a region including the first icons in the design drawing.

12. The information processing method according to claim 5, further comprising:
determining whether the sound information includes utterances of a plurality of persons; and
converting the sound information into text information, wherein
the displaying of the information includes further displaying the text information available to identify each of the persons.

13. An information processing device, comprising:
a processor,
the processor being configured to:
display a bird’s-eye view on a display of an information terminal;
display, in the bird’s-eye view, a plurality of first icons respectively indicating a plurality of photographing spots in connection with photographing times;
acquire content information having been recorded; and
display, in the bird’s-eye view, information showing association of the content information with a first icon having a photographing time that is closer to a recording time for the content information among the first icons.

14. A non-transitory computer readable recording medium storing an information processing program, comprising:
causing a computer to:
display a bird’s-eye view on a display of an information terminal;
display, in the bird’s-eye view, a plurality of first icons respectively indicating a plurality of photographing spots in connection with photographing times;
acquire content information having been recorded; and
display, in the bird’s-eye view, information showing association of the content information with a first icon having a photographing time that is closer to a recording time for the content information among the first icons.
